(19) United States
(12) Patent Application Publication
(10) Pub. No.: US 2025/0136857 A1
(43) Pub. Date: May 1, 2025

(54) PRIMARY EMULSIFIERS FOR INVERT EMULSION FLUIDS

(71) Applicant: INGEVITY SOUTH CAROLINA, LLC, North Charleston, SC (US)

(72) Inventors: Devin Benjamin Granger, North Charleston, SC (US); Russell N. Fitzgerald, North Charleston, SC (US)

(21) Appl. No.: 18/920,092

(22) Filed: Oct. 18, 2024

Related U.S. Application Data
(60) Provisional application No. 63/672,050, filed on Jul. 16, 2024.
(60) Provisional application No. 63/593,742, filed on Oct. 27, 2023.

(51) Int. Cl. C09K 8/32

(52) U.S. Cl. CPC C09K 8/32

(57) ABSTRACT

The present disclosure describes emulsifier composition and methods of making and using the same. The emulsifier composition can include: (a) an emulsifier reaction product made by reacting: a fatty acid composition, a resin acid composition, and a C₃₋₉ carboxylic-acid-bearing dienophile; or (b) an emulsifier blend including a fatty acid reaction product made by reacting a triglyceride composition and a C₃₋₉ carboxylic-acid-bearing dienophile, a resin acid reaction product made by reacting a resin acid composition and a C₃₋₉ carboxylic-acid-bearing dienophile, and an additional fatty acid composition. The present disclosure further describes a drilling fluid including the emulsifier composition of the present disclosure, as well as methods of making and using the same.

### CROSS-REFERENCE TO RELATED APPLICATIONS

The present application claims priority to, and the benefit of, U.S. Provisional Patent Application No. 63/672,050, filed 16 Jul. 2024, and U.S. Provisional Patent Application No. 63/593,742, filed 27 Oct. 2023, each of which is titled PRIMARY EMULSIFIERS FOR INVERT EMULSION FLUIDS and incorporated by reference herein its entirety for all purposes.

### TECHNICAL FIELD

The present disclosure relates to an emulsifier composition that has excellent emulsion stability at high temperature and pressure, while virtually eliminating water filtrate under standard testing conditions. The present disclosure also relates to methods of making the emulsifier composition, drilling fluids comprising the emulsifier composition, and methods of drilling a wellbore.

### BACKGROUND

A drilling fluid (also known as “mud”) is a specially designed fluid that is circulated through an oil or gas wellbore as the wellbore is drilled to facilitate the drilling operation. The drilling fluid can be a water-based drilling fluid (water-based mud) or an oil-based drilling fluid (oil-based mud).

Oil-based drilling fluid or mud is a widely used drilling fluid in the oil and gas production industry. Drilling fluids or muds are used to cool the bit, lubricate the drill string, suspend and transport cuttings, control hydrostatic pressure, and maintain stability. Oil-based drilling fluids or muds, which are also referred to as invert emulsion drilling fluids, are composed of oil as a continuous phase and water as a dispersed phase together with emulsifiers, wetting agents, gellants, etc. The oil phase typically comprises diesel, kerosene, fuel oil, crude oil, or mineral oil. Water-based drilling fluids or muds are composed of water as a continuous phase and oil as a dispersed phase together with, e.g., viscosifiers, fluid loss control agents, weighting agents, lubricants, emulsifiers, corrosion inhibitors, salts, pH control agents, etc.

While emulsifiers for invert emulsion drilling fluids are known, there is a need to find additional raw materials for synthesizing emulsifiers for invert drilling fluids due to limited resources. Thus, there is a need for emulsifiers that utilize and/or are based on alternative raw materials and current chemistries to increase sustainability.

### SUMMARY

Presently described are emulsifier compositions, as well as methods of making and using the same, and drilling fluids or muds comprising the emulsifier compositions of the present disclosure, as well as methods of making and using the same.

An aspect of the present disclosure provides an emulsifier composition comprising, consisting essentially of, or consisting of, an emulsifier reaction product made by a process comprising, consisting essentially of, or consisting of, reacting: a fatty acid composition (e.g., a fatty acid composition present in an amount of about 40.0 wt % to about 75.0 wt % of the reaction mixture); a resin acid composition (e.g., a resin acid composition present in an amount of about 20.0 wt % to about 50.0 wt % of the reaction mixture); and a C₃₋₉ carboxylic-acid-bearing dienophile (e.g., a C₃₋₉ carboxylic-acid-bearing dienophile present in an amount of about 6.0 wt % to about 12.0 wt % of the reaction mixture).

A further aspect of the present disclosure provides a method of making an emulsifier composition of the present disclosure, the method comprising, consisting essentially of, or consisting of, reacting: a fatty acid composition (e.g., a fatty acid composition present in an amount of about 40.0 wt % to about 75.0 wt % of the reaction mixture); a resin acid composition (e.g., a resin acid composition present in an amount of about 20.0 wt % to about 50.0 wt % of the reaction mixture); and a C₃₋₉ carboxylic-acid-bearing dienophile (e.g., a C₃₋₉ carboxylic-acid-bearing dienophile present in an amount of about 6.0 wt % to about 12.0 wt % of the reaction mixture), thereby forming an emulsifier reaction product.

Another aspect of the present disclosure provides an emulsifier composition comprising, consisting essentially of, or consisting of, an emulsifier blend comprising, consisting essentially of, or consisting of: a fatty acid reaction product made by a process comprising, consisting essentially of, or consisting of, reacting a fatty acid composition and a C₃₋₉ carboxylic-acid-bearing dienophile (e.g., the fatty acid composition is present in an amount of about 70.0 wt % to about 90.0 wt % (e.g., about 75.0 wt % to about 80.0 wt %) of the reaction mixture, the C₃₋₉ carboxylic-acid-bearing dienophile present in an amount of about 10.0 wt % to about 30.0 wt % (e.g., about 20.0 wt % to about 25.0 wt %) of the reaction mixture, or a combination thereof); a resin acid reaction product made by a process comprising, consisting essentially of, or consisting of, reacting a resin acid composition and a C₃₋₉ carboxylic-acid-bearing dienophile (e.g., the resin acid composition present in an amount of about 86.0 wt % to about 92.0 wt % (e.g., about 87.0 wt % to about 90.0 wt %) of the reaction mixture, the C₃₋₉ carboxylic-acid-bearing dienophile present in an amount of about 8.0 wt % to about 14.0 wt % (e.g., about 10.0 wt % to about 13.0 wt %) of the reaction mixture, or a combination thereof); and an additional fatty acid composition.

A further aspect of the present disclosure provides a method of making an emulsifier composition of the present disclosure, the method comprising, consisting essentially of, or consisting of, blending: a fatty acid reaction product made by a process comprising, consisting essentially of, or consisting of, reacting a fatty acid composition and a C₃₋₉ carboxylic-acid-bearing dienophile (e.g., the triglyceride composition is present in an amount of about 70.0 wt % to about 90.0 wt % (e.g., about 75.0 wt % to about 80.0 wt %) of the mixture, the C₃₋₉ carboxylic-acid-bearing dienophile present in an amount of about 10.0 wt % to about 30.0 wt % (e.g., about 20.0 wt % to about 25.0 wt %) of the reaction mixture, or a combination thereof); a resin acid reaction product made by a process comprising, consisting essentially of, or consisting of, reacting a resin acid composition and a C₃₋₉ carboxylic-acid-bearing dienophile (e.g., the resin acid composition present in an amount of about 86.0 wt % to about 92.0 wt % (e.g., about 87.0 wt % to about 90.0 wt %) of the reaction mixture, the C₃₋₉ carboxylic-acid-bearing dienophile present in an amount of about 8.0 wt % to about 14.0 wt % (e.g., about 10.0 wt % to about 13.0 wt %) of the reaction mixture, or a combination thereof); and an additional fatty acid composition, thereby forming an emulsifier blend.

In any aspect or embodiment described herein, the reaction mixture of the emulsifier reaction product comprises, consists essentially of, or consists of: (i) the fatty acid composition in an amount of about 40.0 wt % to about 75.0 wt % (e.g., about 53.0 wt % to about 60.0 wt %, about 53.0 wt %, about 54.0 wt %, about 55.0 wt %, about 56.0 wt %, about 57.0 wt %, about 58.0 wt %, about 59.0 wt %, or about 60.0 wt %); (ii) the resin acid composition in an amount of about 20.0 wt % to about 50.0 wt % (e.g., about 30.0 wt % to about 35.0 wt %, about 30.0 wt %, about 31.0 wt %, about 32.0 wt %, about 33.0 wt %, about 34.0 wt %, or about 35.0 wt %); (iii) the C₃₋₉ carboxylic-acid-bearing dienophile in an amount of about 6 wt % to about 12 wt % (e.g., about 10.0 wt % to about 12.0 wt %, about 10.0 wt %, about 11.0 wt %, or about 12.0 wt %); or (iv) a combination thereof.

In any aspect or embodiment described herein, reacting the fatty acid composition, the resin acid composition, and the C₃₋₉ carboxylic-acid-bearing dienophile, comprises, consists essentially of, or consists of: (i) heating the fatty acid composition, the resin acid composition, and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.); (ii) heating the fatty acid composition, the resin acid composition, and the C₃₋₉ carboxylic-acid-bearing dienophile reaction mixture for up to about 6 hours; or (iii) a combination thereof.

In any aspect or embodiment described herein, reacting the fatty acid composition, the resin acid composition, and the C₃₋₉ carboxylic-acid-bearing dienophile, comprises, consists essentially of, or consists of: (i) heating the fatty acid composition, the resin acid composition, and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours); (ii) cooling the emulsifier reaction product (e.g., cooling the emulsifier reaction product to a temperature of about 60° C. to about 100° C., about 60° C. to about 80° C., or about 70° C.); or (iii) a combination thereof.

In any aspect or embodiment described herein, the reaction mixture of the emulsifier reaction product further comprises, consists essentially of, or consists of, a catalyst that isomerize fatty acids into conjugated system (e.g., a catalyst, such as iodine, present in an amount of up to about 1.0 wt % (e.g., up to about 0.8 wt %, up to about 0.6 wt %, up to about 0.4 wt %, up to about 0.2 wt %, about 0.05 wt % to about 1.0 wt %, or about 0.2 wt %) of the reaction mixture).

In any aspect or embodiment described herein, (i) the reaction mixture of the fatty acid reaction product comprises, consists essentially of, or consists of, the fatty acid composition in an amount of about 70.0 wt % to about 90.0 wt % (e.g., about 75.0 wt % to about 80.0 wt %), the C₃₋₉ carboxylic-acid-bearing dienophile in an amount of about 10.0 wt % to about 30.0 wt % % (e.g., about 20.0 wt % to about 25.0 wt %), or a combination thereof; (ii) the reaction mixture of the resin acid reaction product comprises, consists essentially of, or consists of, the resin acid composition in an amount of about 86.0 wt % to about 92.0 wt % (e.g., about 87.0 wt % to about 90.0 wt %), the C₃₋₉ carboxylic-acid-bearing dienophile in an amount of about 8.0 wt % to about 14.0 wt % (e.g., about 10.0 wt % to about 13.0 wt %), or a combination thereof; (iii) the fatty acid reaction product is present in an amount of about 10.0 wt % to about 60.0 wt % (e.g., about 10.0 wt % to about 30.0 wt %) of the emulsifier blend, the resin acid reaction product is present in an amount of about 20.0 wt % to about 55.0 wt % (e.g., about 30.0 wt % to about 50.0 wt %) of the emulsifier blend, the additional fatty acid composition is present in an amount of about 20.0 wt % to about 50.0 wt % (e.g., about 40.0 wt % to about 60.0 wt %) of the emulsifier blend, or a combination thereof; or (iv) a combination thereof.

In any aspect or embodiment descried herein, the emulsifier blend comprises, consists essentially of, or consists of: (a) the combination of the fatty acid reaction product and the resin acid reaction product are present in an amount of about 45.0 wt % to about 80.0 wt %; (b) a ratio of resin acid reaction product to fatty acid reaction product is about 1:5 to about 5:1; or (c) a combination thereof.

In any aspect or embodiment described herein, reacting a fatty acid composition and a C₃₋₉ carboxylic-acid-bearing dienophile comprises, consists essentially of, or consists of: (i) heating the fatty acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.); (ii) heating the fatty acid composition and the C₃₋₉ carboxylic-acid-bearing dienophile reaction mixture for up to about 6 hours; or (iii) a combination thereof.

In any aspect or embodiment described herein, reacting a resin acid composition and a C₃₋₉ carboxylic-acid-bearing dienophile comprises, consists essentially of, or consists of: (i) heating the resin acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.); (ii) heating the resin acid composition and the C₃₋₉ carboxylic-acid-bearing dienophile reaction mixture for up to about 6 hours; or (iii) a combination thereof.

In any aspect or embodiment described herein, reacting a fatty acid composition and a C₃₋₉ carboxylic-acid-bearing dienophile comprises, consists essentially of, or consists of: (i) heating the fatty acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours); (ii) cooling the fatty acid reaction product (e.g., cooling the emulsifier reaction product to a temperature of about 60° C. to about 100° C., about 60° C. to about 80° C., or about 70° C.); or (iii) a combination thereof.

In any aspect or embodiment described herein, reacting a resin acid composition and a C₃₋₉ carboxylic-acid-bearing dienophile comprises, consists essentially of, or consists of: (i) heating the resin acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours); (ii) cooling the resin acid reaction product (e.g., cooling the emulsifier reaction product to a temperature of about 60° C. to about 100° C., about 60° C. to about 80° C., or about 70° C.); or (iii) a combination thereof.

In any aspect or embodiment described herein, the further comprises, consists essentially of, or consists of, blending the fatty acid reaction product, the resin acid reaction product, and the additional fatty acid composition.

In any aspect or embodiment described herein, (i) the reaction mixture of the fatty acid reaction product further comprises, consists essentially of, or consists of, a catalyst that isomerize fatty acids into conjugated system (e.g., catalyst, such as iodine, present in an amount of up to about 0.5 wt % of the reaction mixture); (ii) the reaction mixture of the resin acid reaction product further comprises, consists essentially of, or consists of, a catalyst that isomerize fatty acids into conjugated system (e.g., catalyst, such as iodine, present in an amount of up to about 0.5 wt % of the reaction mixture); or (iii) a combination thereof.

In any aspect or embodiment described herein, the fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof.

In any aspect ore embodiment described herein, the additional fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof.

In any aspect or embodiment described herein, the vegetable oil fatty acid composition includes, is, or is derived from, vegetable oil, soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof.

In any aspect or embodiment described herein, (i) the resin acid composition includes or is one or more carboxylic acids, wherein each carboxylic acid has (a) three fused rings, (b) one acid group, (c) the formula C₁₉H₂₉COOH, C₂₀H₂₈O₂, or C₂₀H₃₀O₂, or (d) a combination thereof; (ii) the resin acid composition includes or is one or more C₁₉₋₂₀ tricyclic terpenoids (e.g., one or more tricyclic terpenoid, each independently having the formula C₁₉H₂₉COOH, C₂₀H₂₈O₂, or C₂₀H₃₀O₂); or (iii) a combination thereof.

In any aspect or embodiment described herein, the resin acid composition includes or is palustric acid, abietic acid, neoabietic acid, pimaric acid, isopimaric acid, dehydroabietic acid, rosin, tall oil rosin (TOR), gum rosin, wood rosin, or a combination thereof.

In any aspect or embodiment described herein, the C₃₋₉ carboxylic-acid-bearing dienophile includes or is maleic acid, maleic anhydride, fumaric acid, itaconic acid, or a combination thereof.

In any aspect or embodiment described herein, (i) the fatty acid composition includes or is vegetable oil fatty acid composition or vegetable oil; (ii) the resin acid composition includes or is rosin or tall oil rosin (TOR); (iii) the C₃₋₉ carboxylic-acid-bearing dienophile includes or is fumaric acid, itaconic acid, or a combination thereof; or (iv) a combination thereof.

Another aspect of the present disclosure provides an oil-based drilling fluid comprising, consisting essentially of, or consisting of, an invert emulsion of a hygroscopic liquid (e.g., a brine, such as CaCl₂) brine), one or more emulsifier, and at least one of: an oil, mineral oil, synthetic oil (e.g., one or more of internal olefin, poly alpha olefin, and linear paraffin), or a combination thereof, wherein the one or more emulsifiers includes the emulsifier composition of the present disclosure, an emulsifier composition produced according to the method of the present disclosure, or a combination thereof.

In any aspect or embodiment described herein, (i) the oil is diesel; (ii) the hygroscopic liquid is CaCl₂) brine, NaCl brine, NaBr brine, CaBr₂ brine, formate brine, potassium formate, an alcohol based hygroscopic liquid, lower polyhydric alcohols, glycerol, or polyglycerol (e.g., CaCl₂) brine); or (iii) a combination thereof.

In any aspect or embodiment described herein, the oil-based drilling fluid further comprising, consisting essentially of, or consisting of: (i) one or more weighting agents (e.g., barite); (ii) one or more rheological modifier (e.g., at least one of: clay, organophilic clay, organoclay, bentonite clay, amine-treated clay, amine-treated bentonite clay, polyamide, dimer diacid, or combinations thereof); (iii) one or more alkalinity agent (e.g., lime, CaO, or Ca(OH)₂); (iv) one or more wetting agent (e.g., fatty imidazolines, soya lecithin, or combinations thereof); or (v) a combination thereof.

In any aspect or embodiment described herein, the oil-based drilling fluid comprises an invert emulsion of a hygroscopic liquid (e.g., a brine, such as CaCl₂) brine), the emulsifier composition, and an oil that includes diesel, mineral oil, and/or internal olefin.

A further aspect of the present disclosure provides a method of drilling a wellbore, the method comprising circulating the oil-based drilling fluid of the present disclosure through the wellbore when drilling (e.g., when drilling the well to depth).

The preceding general areas of utility are given by way of example only and are not intended to be limiting on the scope of the present disclosure and appended claims. Additional objects and advantages associated with the polymers, compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating embodiments of the disclosure, are not necessarily drawn to scale, and are not to be construed as limiting the disclosure. Further objects, features, and advantages of the disclosure will become apparent from the following detailed description taken in conjunction with the accompanying FIGURES showing illustrative embodiments of the disclosure.

FIG. 1. Pictures comparing exemplary Emulsifier 7 (0.1% iodine) and exemplary Emulsifier 8 (0.3% iodine). Both contained 12% fumaric acid reacted with a mixture of 20% rosin acids and 80% Alta Veg™ FFA. Exemplary Emulsifier 7 is cloudy and exemplary Emulsifier 8 is homogenous.

### DETAILED DESCRIPTION

The inventors of the present disclosure have surprisingly and unexpectedly discovered that emulsifiers formulations of the present disclosure produced stable emulsions, as demonstrated through fluid loss control under high temperature, high pressure conditions, as compared to other emulsifiers (e.g., maleated tall oil or oxidized fatty acids). When the emulsifiers of the present disclosure were examined in oil-based/invert drilling muds/fluids under high temperature and high pressure, fluid loss was less than 10 mL, an important industry standard, while having little water filtrate observed for the tested formulations. It was also surprisingly and unexpectedly discovered that the use of the catalyst (e.g., iodine) in the reaction mixture of the emulsifiers of the present disclosure prevented settling out of the solution; rather, the use of the catalyst (e.g., iodine) surprisingly and unexpectedly resulted in the production of a homogenous solution that is not plagued by solids settling out of the solution. resulted in a significant decrease in the viscosity of the emulsifier of the present disclosure.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either/or both of those included limits are also included in the disclosure.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “effective” is used to describe an amount of a compound, composition, or component which, when used within the context of its intended use, affects an intended result. The term effective subsumes all other effective amount or effective concentration terms, which are otherwise described or used in the present application.

### Emulsifier Compositions and Methods of Making the Same

As discussed herein, the inventors of the present disclosure surprisingly and unexpectedly discovered that emulsifier compositions of the present disclosure produce highly stable emulsions with little to no water filtrate observed.

### Emulsifier Reaction Product

An aspect of the present disclosure provides an emulsifier composition comprising, consisting essentially of, or consisting of, an emulsifier reaction product made by a process comprising, consisting essentially of, or consisting of, reacting: a fatty acid composition (e.g., a fatty acid composition present in an amount of about 40.0 wt % to about 75.0 wt % of the reaction mixture); a resin acid composition (e.g., a resin acid composition present in an amount of about 20.0 wt % to about 50.0 wt % of the reaction mixture); and a C₃₋₉ carboxylic-acid-bearing dienophile (e.g., a C₃₋₉ carboxylic-acid-bearing dienophile present in an amount of about 6.0 wt % to about 12.0 wt % of the reaction mixture).

A further aspect of the present disclosure provides a method of making an emulsifier composition of the present disclosure, the method comprising, consisting essentially of, or consisting of, reacting: a fatty acid composition (e.g., a fatty acid composition present in an amount of about 40.0 wt % to about 75.0 wt % of the reaction mixture); a resin acid composition (e.g., a resin acid composition present in an amount of about 20.0 wt % to about 50.0 wt % of the reaction mixture); and a C₃₋₉ carboxylic-acid-bearing dienophile (e.g., a C₃₋₉ carboxylic-acid-bearing dienophile present in an amount of about 6.0 wt % to about 12.0 wt % of the reaction mixture), thereby forming an emulsifier reaction product.

In any aspect or embodiment described herein, (i) the fatty acid composition is present in an amount of about 40.0 wt % to about 75.0 wt % of the reaction mixture; (ii) the resin acid composition is present in an amount of about 20.0 wt % to about 50.0 wt % of the reaction mixture; (iii) the C₃₋₉ carboxylic-acid-bearing dienophile is present in an amount of about 6.0 wt % to about 12.0 wt % of the reaction mixture; or (iv) a combination thereof.

In any aspect or embodiment described herein, (i) the fatty acid composition is present in an amount of about 53.0 wt % to about 60.0 wt % (e.g., about 53.0 wt %, about 54.0 wt %, about 55.0 wt %, about 56.0 wt %, about 57.0 wt %, about 58.0 wt %, about 59.0 wt %, or about 60.0 wt %) of the reaction mixture; (ii) the resin acid composition present in an amount of about 30.0 wt % to about 35.0 wt % (e.g., about 30.0 wt %, about 31.0 wt %, about 32.0 wt %, about 33.0 wt %, about 34.0 wt %, or about 35.0 wt %) of the reaction mixture; (iii) the C₃₋₉ carboxylic-acid-bearing dienophile present in an amount of about 10.0 wt % to about 12.0 wt % (e.g., about 10.0 wt %, about 11.0 wt %, or about 12.0 wt %) of the reaction mixture; or (iv) a combination thereof.

In any aspect or embodiment described herein, the fatty acid composition is present in an amount of about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 40.0 wt % to about 45.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 45.0 wt % to about 50.0 wt %, about 50.0 wt % to about 75.0 wt %, about 50.0 wt % to about 70.0 wt %, about 50.0 wt % to about 65.0 wt %, about 50.0 wt % to about 60.0 wt %, about 50.0 wt % to about 55.0 wt %, about 55.0 wt % to about 75.0 wt %, about 55.0 wt % to about 70.0 wt %, about 55.0 wt % to about 65.0 wt %, about 55.0 wt % to about 60.0 wt %, about 60.0 wt % to about 75.0 wt %, about 60.0 wt % to about 70.0 wt %, about 60.0 wt % to about 65.0 wt %, about 65.0 wt % to about 75.0 wt %, about 65.0 wt % to about 70.0 wt %, or about 70.0 wt % to about 75.0 wt % of the reaction mixture for the emulsifier reaction product.

In any aspect or embodiment described herein, the resin acid composition is present in an amount of about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 20.0 wt % to about 35.0 wt %, about 25.0 wt % to about 50.0 wt %, about 25.0 wt % to about 45.0 wt %, about 25.0 wt % to about 40.0 wt %, about 25.0 wt % to about 35.0 wt %, about 25.0 wt % to about 30.0 wt %, about 30.0 wt % to about 50.0 wt %, about 30.0 wt % to about 45.0 wt %, about 30.0 wt % to about 40.0 wt %, about 30.0 wt % to about 35.0 wt %, about 35.0 wt % to about 50.0 wt %, about 35.0 wt % to about 45.0 wt %, about 35.0 wt % to about 40.0 wt %, about 40.0 wt % to about 50.0 wt %, about 40.0 wt % to about 45.0 wt %, or about 45.0 wt % to about 50.0 of the reaction mixture for the emulsifier reaction product.

In any aspect or embodiment described herein, the C₃₋₉ carboxylic-acid-bearing dienophile is present in an amount of about 6.0 wt % to about 12.0 wt %, about 6.0 wt % to about 11.0 wt %, about 6.0 wt % to about 10.0 wt %, about 6.0 wt % to about 9.0 wt %, about 6.0 wt % to about 8.0 wt %, about 6.0 wt % to about 7.0 wt %, about 7.0 wt % to about 12.0 wt %, about 7.0 wt % to about 11.0 wt %, about 7.0 wt % to about 10.0 wt %, about 7.0 wt % to about 9.0 wt %, about 7.0 wt % to about 8.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 12.0 wt %, about 9.0 wt % to about 11.0 wt %, about 9.0 wt % to about 10.0 wt %, about 10.0 wt % to about 12.0 wt %, about 10.0 wt % to about 11.0 wt %, about 11.0 wt % to about 12.0 wt %, of the reaction mixture for the emulsifier reaction product.

In any aspect or embodiment described herein, reacting the fatty acid composition, the resin acid composition, and the C₃₋₉ carboxylic-acid-bearing dienophile, comprises, consists essentially of, or consists of, heating the fatty acid composition, the resin acid composition, and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.). For example, in any aspect or embodiment described herein, the fatty acid composition, the resin acid composition, and the C₃₋₉ carboxylic-acid-bearing dienophile reaction mixture is heated to about 200° C. to about 240° C., about 200° C. to about 235° C., about 200° C. to about 230° C., about 200° C. to about 225° C., about 200° C. to about 220° C., about 200° C. to about 215° C., about 200° C. to about 210° C., about 205° C. to about 240° C., about 205° C. to about 235° C., about 205° C. to about 230° C., about 205° C. to about 225° C., about 205° C. to about 220° C., about 205° C. to about 215° C., about 210° C. to about 240° C., about 210° C. to about 235° C., about 210° C. to about 230° C., about 210° C. to about 225° C., about 210° C. to about 220° C., about 215° C. to about 240° C., about 215° C. to about 235° C., about 215° C. to about 230° C., about 215° C. to about 225° C., about 220° C. to about 240° C., about 220° C. to about 235° C., about 220° C. to about 230° C., about 225° C. to about 240° C., about 225° C. to about 235° C., or about 230° C. to about 240° C.

In any aspect or embodiment described herein, reacting the fatty acid composition, the resin acid composition, and the C₃₋₉ carboxylic-acid-bearing dienophile, comprises, consists essentially of, or consists of, heating the fatty acid composition, the resin acid composition, and the C₃₋₉ carboxylic-acid-bearing dienophile reaction mixture for up to about 6 hours. For example, in any aspect or embodiment described herein, the fatty acid composition, the resin acid composition, and the C₃₋₉ carboxylic-acid-bearing dienophile reaction mixture is heated for up to about 6 hours, up to about 5.5 hours, up to about 5 hours, up to about 4.5 hours, up to about 4 hours, up to about 3.5 hours, up to about 3 hours, up to about 2.5 hours, up to about 2 hours, up to about 1.5 hours up to about an hour, up to about 0.5 hours, about 0.5 hours to about 6 hours, about 0.5 hours to about 5.5 hours, about 0.5 hours to about 5 hours, about 0.5 hours to about 4.5 hours, about 0.5 hours to about 4 hours, about 0.5 hours to about 3.5 hours, about 0.5 hours to about 3 hours, about 0.5 hours to about 2.5 hours, about 0.5 hours to about 2 hours, about 0.5 hours to about 1.5 hours, about 1 hour to about 6 hours, about 1 hour to about 5.5 hours, about 1 hour to about 5 hours, about 1 hour to about 4.5 hours, about 1 hour to about 4 hours, about 1 hour to about 3.5 hours, about 1 hour to about 3 hours, about 1 hour to about 2.5 hours, about 1 hour to about 2 hours, about 1.5 hours to about 6 hours, about 1.5 hours to about 5.5 hours, about 1.5 hours to about 5 hours, about 1.5 hours to about 4.5 hours, about 1.5 hours to about 4 hours, about 1.5 hours to about 3.5 hours, about 1.5 hours to about 3 hours, about 1.5 hours to about 2.5 hours, about 2 hours to about 6 hours, about 2 hours to about 5.5 hours, about 2 hours to about 5 hours, about 2 hours to about 4.5 hours, about 2 hours to about 4 hours, about 2 hours to about 3.5 hours, about 2 hours to about 3 hours, about 2.5 hours to about 6 hours, about 2.5 hours to about 5.5 hours, about 2.5 hours to about 5 hours, about 2.5 hours to about 4.5 hours, about 2.5 hours to about 4 hours, about 2.5 hours to about 3.5 hours, about 3 hours to about 6 hours, about 3 hours to about 5.5 hours, about 3 hours to about 5 hours, about 3 hours to about 4.5 hours, about 3 hours to about 4 hours, about 3.5 hours to about 6 hours, about 3.5 hours to about 5.5 hours, about 3.5 hours to about 5 hours, about 3.5 hours to about 4.5 hours, about 4 hours to about 6 hours, about 4 hours to about 5.5 hours, about 4 hours to about 5 hours, about 4.5 hours to about 6 hours, about 4.5 hours to about 5.5 hours, about 5 hours to about 6 hours.

In any aspect or embodiment described herein, reacting the fatty acid composition, the resin acid composition, and the C₃₋₉ carboxylic-acid-bearing dienophile, comprises, consists essentially of, or consists of, heating the fatty acid composition, the resin acid composition, and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours).

In any aspect or embodiment described herein, reacting the fatty acid composition, the resin acid composition, and the C₃₋₉ carboxylic-acid-bearing dienophile, comprises, consists essentially of, or consists of, cooling the emulsifier reaction product (e.g., cooling the emulsifier reaction product to a temperature of about 60° C. to about 100° C., about 60° C. to about 80° C., or about 70° C.).

In any aspect or embodiment described herein, the reaction mixture of the emulsifier reaction product further comprises, consists essentially of, or consists of, a catalyst that isomerize fatty acids into conjugated system (e.g., a catalyst, such as iodine, is present in an amount of up to about 1.0 wt % (e.g., up to about 0.8 wt %, up to about 0.6 wt %, up to about 0.4 wt %, up to about 0.2 wt %, about 0.05 wt % to about 1.0 wt %, or about 0.2 wt % of the reaction mixture). For example, in any aspect or embodiment described herein, the catalyst that isomerize fatty acids into conjugated system is present in an amount of up to about 1.0 wt %, up to about 0.9 wt %, up to about 0.8 wt %, up to about 0.7 wt %, up to about 0.6 wt %, up to about 0.5 wt %, up to about 0.4 wt %, up to about 0.3 wt %, up to about 0.2 wt %, up to about 0.1 wt %, about 0.05 wt % to about 1.0 wt %, about 0.05 wt % to about 0.9 wt %, about 0.05 wt % to about 0.8 wt %, about 0.05 wt % to about 0.6 wt %, about 0.05 wt % to about 0.4 wt %, about 0.05 wt % to about 0.2 wt %, about 0.1 wt % to about 1.0 wt %, about 0.1 wt % to about 0.9 wt %, about 0.1 wt % to about 0.8 wt %, about 0.1 wt % to about 0.6 wt %, about 0.1 wt % to about 0.4 wt %, about 0.1 wt % to about 0.2 wt %, about 0.2 wt % to about 1.0 wt %, about 0.2 wt % to about 0.9 wt %, about 0.2 wt % to about 0.8 wt %, about 0.2 wt % to about 0.6 wt %, about 0.2 wt % to about 0.4 wt %, about 0.3 wt % to about 1.0 wt %, about 0.3 wt % to about 0.9 wt %, about 0.3 wt % to about 0.8 wt %, about 0.3 wt % to about 0.6 wt %, about 0.3 wt % to about 0.5 wt %, about 0.4 wt % to about 1.0 wt %, about 0.4 wt % to about 0.9 wt %, about 0.4 wt % to about 0.8 wt %, about 0.4 wt % to about 0.6 wt %, about 0.5 wt % to about 1.0 wt %, about 0.5 wt % to about 0.9 wt %, about 0.5 wt % to about 0.8 wt %, about 0.5 wt % to about 0.7 wt %, about 0.6 wt % to about 1.0 wt %, about 0.6 wt % to about 0.9 wt %, about 0.6 wt % to about 0.8 wt %, about 0.7 wt % to about 1.0 wt %, about 0.7 wt % to about 0.9 wt %, or about 0.8 wt % to about 1.0 wt % of the reaction mixture of the emulsifier reaction product.

### Emulsifier Blend

Another aspect of the present disclosure provides an emulsifier composition comprising, consisting essentially of, or consisting of, an emulsifier blend comprising, consisting essentially of, or consisting of: a fatty acid reaction product made by a process comprising, consisting essentially of, or consisting of, reacting a fatty acid composition and a C₃₋₉ carboxylic-acid-bearing dienophile (e.g., the fatty acid composition is present in an amount of about 70.0 wt % to about 90.0 wt % (e.g., about 75.0 wt % to about 80.0 wt %) of the reaction mixture, the C₃₋₉ carboxylic-acid-bearing dienophile present in an amount of about 10.0 wt % to about 30.0 wt % (e.g., about 20.0 wt % to about 25.0 wt %) of the reaction mixture, or a combination thereof); a resin acid reaction product made by a process comprising, consisting essentially of, or consisting of, reacting a resin acid composition and a C₃₋₉ carboxylic-acid-bearing dienophile (e.g., the resin acid composition present in an amount of about 86.0 wt % to about 92.0 wt % (e.g., about 87.0 wt % to about 90.0 wt %) of the reaction mixture, the C₃₋₉ carboxylic-acid-bearing dienophile present in an amount of about 8.0 wt % to about 14.0 wt % (e.g., about 10.0 wt % to about 13.0 wt %) of the reaction mixture, or a combination thereof); and an additional fatty acid composition.

A further aspect of the present disclosure provides a method of making an emulsifier composition of the present disclosure, the method comprising, consisting essentially of, or consisting of, blending: a fatty acid reaction product made by a process comprising, consisting essentially of, or consisting of, reacting a fatty acid composition and a C₃₋₉ carboxylic-acid-bearing dienophile (e.g., the fatty acid composition is present in an amount of about 70.0 wt % to about 90.0 wt % (e.g., about 75.0 wt % to about 80.0 wt %) of the mixture, the C₃₋₉ carboxylic-acid-bearing dienophile present in an amount of about 10 wt % to about 30.0 wt % (e.g., about 20.0 wt % to about 25.0 wt %) of the reaction mixture, or a combination thereof); a resin acid reaction product made by a process comprising, consisting essentially of, or consisting of, reacting a resin acid composition and a C₃₋₉ carboxylic-acid-bearing dienophile (e.g., the resin acid composition present in an amount of about 86.0 wt % to about 92.0 wt % (e.g., about 87.0 wt % to about 90.0 wt %) of the reaction mixture, the C₃₋₉ carboxylic-acid-bearing dienophile present in an amount of about 8.0 wt % to about 14.0 wt % (e.g., about 10.0 wt % to about 13.0 wt %) of the reaction mixture, or a combination thereof); and an additional fatty acid composition, thereby forming an emulsifier blend.

In any aspect or embodiment described herein, the method further comprises, consists essentially of, or consists of, blending the fatty acid reaction product, the resin acid reaction product, and the additional fatty acid composition.

In any aspect or embodiment described herein, the reaction mixture of the fatty acid reaction product comprises, consists essentially of, or consists of, the fatty acid composition in an amount of about 70.0 wt % to about 90.0 wt % (e.g., about 75.0 wt % to about 80.0 wt %), the C₃₋₉ carboxylic-acid-bearing dienophile in an amount of about 10.0 wt % to about 30.0 wt % (e.g., about 20.0 wt % to about 25.0 wt %), or a combination thereof. For example, in any aspect or embodiment described herein, the fatty acid composition is present in the reaction mixture of fatty acid reaction product in an amount of about 70.0 wt % to about 90.0 wt %, about 70.0 wt % to about 85.0 wt %, about 70.0 wt % to about 80.0 wt %, about 70.0 wt % to about 75.0 wt %, about 75.0 wt % to about 90.0 wt %, about 75.0 wt % to about 85.0 wt %, about 75.0 wt % to about 80.0 wt %, about 80.0 wt % to about 90.0 wt %, about 80.0 wt % to about 85.0 wt %, or about 85.0 wt % to about 90.0 wt %. By way of further example, in any aspect or embodiment described herein, the C₃₋₉ carboxylic-acid-bearing dienophile is present in the reaction mixture of fatty acid reaction product in an amount of about 10.0 wt % to about 30.0 wt %, about 10.0 wt % to about 25.0 wt %, about 10.0 wt % to about 20.0 wt %, about 10.0 wt % to about 15.0 wt %, about 15.0 wt % to about 30.0 wt %, about 15.0 wt % to about 25.0 wt %, about 15.0 wt % to about 20.0 wt %, about 20.0 wt % to about 30.0 wt %, about 20.0 wt % to about 25.0 wt %, or about 25.0 wt % to about 30.0 wt %.

In any aspect ore embodiment described herein, the reaction mixture of the resin acid reaction product comprises, consists essentially of, or consists of, the resin acid composition in an amount of about 86.0 wt % to about 92.0 wt % (e.g., about 87.0 wt % to about 90.0 wt %), the C₃₋₉ carboxylic-acid-bearing dienophile in an amount of about 8.0 wt % to about 14.0 wt % (e.g., about 10.0 wt % to about 13.0 wt %), or a combination thereof. For example, in any aspect or embodiment described herein, the resin acid composition is present in the reaction mixture of resin acid reaction product in an amount of about 86.0 wt % to about 92.0 wt %, about 86.0 wt % to about 91.0 wt %, about 86.0 wt % to about 90.0 wt %, about 86.0 wt % to about 89.0 wt %, about 86.0 wt % to about 88.0 wt %, about 86.0 wt % to about 87.0 wt %, about 87.0 wt % to about 92.0 wt %, about 87.0 wt % to about 91.0 wt %, about 87.0 wt % to about 90.0 wt %, about 87.0 wt % to about 89.0 wt %, about 87.0 wt % to about 88.0 wt %, about 89.0 wt % to about 92.0 wt %, about 89.0 wt % to about 91.0 wt %, about 89.0 wt % to about 90.0 wt %, about 90.0 wt % to about 92.0 wt %, about 90.0 wt % to about 91.0 wt %, or about 91.0 wt % to about 92.0 wt %. By way of further example, in any aspect or embodiment described herein, the C₃₋₉ carboxylic-acid-bearing dienophile is present in the reaction mixture of resin acid reaction product in an amount of about 8.0 wt % to about 14.0 wt %, about 8.0 wt % to about 13.0 wt %, about 8.0 wt % to about 12.0 wt %, about 8.0 wt % to about 11.0 wt %, about 8.0 wt % to about 10.0 wt %, about 8.0 wt % to about 9.0 wt %, about 9.0 wt % to about 14.0 wt %, about 9.0 wt % to about 13.0 wt %, about 9.0 wt % to about 12.0 wt %, about 9.0 wt % to about 11.0 wt %, about 9.0 wt % to about 10.0 wt %, about 10.0 wt % to about 14.0 wt %, about 10.0 wt % to about 13.0 wt %, about 10.0 wt % to about 12.0 wt %, about 10.0 wt % to about 11.0 wt %, about 11.0 wt % to about 14.0 wt %, about 11.0 wt % to about 13.0 wt %, about 11.0 wt % to about 12.0 wt %, about 12.0 wt % to about 14.0 wt %, about 12.0 wt % to about 13.0 wt %, about 13.0 wt % to about 14.0 wt %.

In any aspect or embodiment described herein, the fatty acid reaction product is present in an amount of about 10.0 wt % to about 60.0 wt % (e.g., about 10.0 wt % to about 30.0 wt %) of the emulsifier blend, the resin acid reaction product is present in an amount of about 20.0 wt % to about 55.0 wt % (e.g., about 30.0 wt % to about 50.0 wt %) of the emulsifier blend, the additional fatty acid composition is present in an amount of about 20.0 wt % to about 50.0 wt % (e.g., about 40.0 wt % to about 60.0 wt %) of the emulsifier blend, or a combination thereof, or a combination thereof; or a combination thereof. For example, in any aspect or embodiment described herein, the fatty acid reaction product is present in an amount of about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 60.0 wt %, about 40.0 wt % to about 55.0 wt %, about 40.0 wt % to about 50.0 wt %, about 45.0 wt % to about 60.0 wt %, about 45.0 wt % to about 55.0 wt %, or about 50.0 wt % to about 60.0 wt % of the emulsifier blend. By way of further example, in any aspect or embodiment described herein, the resin acid reaction product is present in an amount of about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 55.0 wt %, about 35.0 wt % to about 50.0 wt %, about 35.0 wt % to about 45.0 wt %, about 40.0 wt % to about 55.0 wt %, about 40.0 wt % to about 50.0 wt %, or about 45.0 wt % to about 55.0 wt % of the emulsifier blend. Further, in any aspect or embodiment described herein, the additional fatty acid composition is present in an amount of about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 50.0 wt %, about 30.0 wt % to about 45.0 wt %, about 30.0 wt % to about 40.0 wt %, about 35.0 wt % to about 50.0 wt %, about 35.0 wt % to about 45.0 wt %, or about 40.0 wt % to about 50.0 wt % of the emulsifier blend.

In any aspect or embodiment descried herein, the emulsifier blend comprises, consists essentially of, or consists of: (a) the combination of the fatty acid reaction product and the resin acid reaction product are present in an amount of about 45.0 wt % to about 80.0 wt %; (b) a ratio of resin acid reaction product to fatty acid reaction product is about 1:5 to about 5:1; or (c) a combination thereof. For example, in any aspect or embodiment described herein, the combination of the fatty acid reaction product and the resin acid reaction product are present in an amount of about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 45.0 wt % to about 50.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 50.0 wt % to about 55.0 wt %, about 55.0 wt % to about 80.0 wt %, about 55.0 wt % to about 75.0 wt %, about 55.0 wt % to about 70.0 wt %, about 55.0 wt % to about 65.0 wt %, about 55.0 wt % to about 60.0 wt %, about 60.0 wt % to about 80.0 wt %, about 60.0 wt % to about 75.0 wt %, about 60.0 wt % to about 70.0 wt %, about 60.0 wt % to about 65.0 wt %, about 65.0 wt % to about 80.0 wt %, about 65.0 wt % to about 75.0 wt %, about 65.0 wt % to about 70.0 wt %, about 70.0 wt % to about 80.0 wt %, about 70.0 wt % to about 75.0 wt %, or about 78.0 wt % to about 80.0 wt %. By way of further example, in any aspect or embodiment described herein, ratio of resin acid reaction product to fatty acid reaction product is about 1:5 to about 5:1, about 1:5 to about 9:2, about 1:5 to about 4:1, about 1:5 to about 7:2, about 1:5 to about 3:1, about 1:5 to about 5:2, about 1:5 to about 2:1, about 1:5 to about 3:2, about 1:5 to about 1:1, about 1:5 to about 5:6, about 1:5 to about 2:3, about 1:5 to about 1:2, about 1:5 to about 1:3, about 1:3 to about 5:1, about 1:3 to about 9:2, about 1:3 to about 4:1, about 1:3 to about 7:2, about 1:3 to about 3:1, about 1:3 to about 5:2, about 1:3 to about 2:1, about 1:3 to about 3:2, about 1:3 to about 1:1, about 1:3 to about 5:6, about 1:3 to about 2:3, about 1:3 to about 1:2, about 1:2 to about 5:1, about 1:2 to about 9:2, about 1:2 to about 4:1, about 1:2 to about 7:2, about 1:2 to about 3:1, about 1:2 to about 5:2, about 1:2 to about 2:1, about 1:2 to about 3:2, about 1:2 to about 1:1, about 1:2 to about 5:6, about 1:2 to about 2:3, about 2:3 to about 5:1, about 2:3 to about 9:2, about 2:3 to about 4:1, about 2:3 to about 7:2, about 2:3 to about 3:1, about 2:3 to about 5:2, about 2:3 to about 2:1, about 2:3 to about 3:2, about 2:3 to about 1:1, about 2:3 to about 5:6, about 5:6 to about 5:1, about 5:6 to about 9:2, about 5:6 to about 4:1, about 5:6 to about 7:2, about 5:6 to about 3:1, about 5:6 to about 5:2, about 5:6 to about 2:1, about 5:6 to about 3:2, about 5:6 to about 1:1, about 1:1 to about 5:1, about 1:1 to about 9:2, about 1:1 to about 4:1, about 1:1 to about 7:2, about 1:1 to about 3:1, about 1:1 to about 5:2, about 1:1 to about 2:1, about 1:1 to about 3:2, about 3:2 to about 5:1, about 3:2 to about 9:2, about 3:2 to about 4:1, about 3:2 to about 7:2, about 3:2 to about 3:1, about 3:2 to about 5:2, about 3:2 to about 2:1, about 2:1 to about 5:1, about 2:1 to about 9:2, about 2:1 to about 4:1, about 2:1 to about 7:2, about 2:1 to about 3:1, about 2:1 to about 5:2, about 5:2 to about 5:1, about 5:2 to about 9:2, about 5:2 to about 4:1, about 5:2 to about 7:2, about 5:2 to about 3:1, about 3:1 to about 5:1, about 3:1 to about 9:2, about 3:1 to about 4:1, about 3:1 to about 7:2, about 7:2 to about 5:1, about 7:2 to about 9:2, about 7:2 to about 4:1, about 4:1 to about 5:1, about 4:1 to about 9:2, or about 9:2 to about 5:1.

In any aspect or embodiment described herein, reacting a fatty acid composition and a C₃₋₉ carboxylic-acid-bearing dienophile comprises, consists essentially of, or consists of: (i) heating the fatty acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.); (ii) heating the fatty acid composition and the C₃₋₉ carboxylic-acid-bearing dienophile reaction mixture for up to about 6 hours; or (iii) a combination thereof.

In any aspect or embodiment described herein, reacting a fatty acid composition and a C₃₋₉ carboxylic-acid-bearing dienophile comprises, consists essentially of, or consists of: (i) heating the fatty acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours); (ii) cooling the fatty acid reaction product (e.g., cooling the emulsifier reaction product to a temperature of about 60° C. to about 100° C., about 60° C. to about 80° C., or about 70° C.); or (iii) a combination thereof.

In any aspect or embodiment described herein, reacting a fatty acid composition and a C₃₋₉ carboxylic-acid-bearing dienophile comprises, consists essentially of, or consists of, heating the fatty acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.). For example, in any aspect or embodiment described herein, the fatty acid composition and the C₃₋₉ carboxylic-acid-bearing dienophile reaction mixture is heated to about 200° C. to about 240° C., about 200° C. to about 235° C., about 200° C. to about 230° C., about 200° C. to about 225° C., about 200° C. to about 220° C., about 200° C. to about 215° C., about 200° C. to about 210° C., about 205° C. to about 240° C., about 205° C. to about 235° C., about 205° C. to about 230° C., about 205° C. to about 225° C., about 205° C. to about 220° C., about 205° C. to about 215° C., about 210° C. to about 240° C., about 210° C. to about 235° C., about 210° C. to about 230° C., about 210° C. to about 225° C., about 210° C. to about 220° C., about 215° C. to about 240° C., about 215° C. to about 235° C., about 215° C. to about 230° C., about 215° C. to about 225° C., about 220° C. to about 240° C., about 220° C. to about 235° C., about 220° C. to about 230° C., about 225° C. to about 240° C., about 225° C. to about 235° C., or about 230° C. to about 240° C.

In any aspect or embodiment described herein, reacting the fatty acid composition and a C₃₋₉ carboxylic-acid-bearing dienophile comprises, consists essentially of, or consists of, heating the fatty acid composition and the C₃₋₉ carboxylic-acid-bearing dienophile reaction mixture for up to about 6 hours. For example, in any aspect or embodiment described herein, the fatty acid composition and the C₃₋₉ carboxylic-acid-bearing dienophile reaction mixture is heated for up to about 6 hours, up to about 5.5 hours, up to about 5 hours, up to about 4.5 hours, up to about 4 hours, up to about 3.5 hours, up to about 3 hours, up to about 2.5 hours, up to about 2 hours, up to about 1.5 hours up to about an hour, up to about 0.5 hours, about 0.5 hours to about 6 hours, about 0.5 hours to about 5.5 hours, about 0.5 hours to about 5 hours, about 0.5 hours to about 4.5 hours, about 0.5 hours to about 4 hours, about 0.5 hours to about 3.5 hours, about 0.5 hours to about 3 hours, about 0.5 hours to about 2.5 hours, about 0.5 hours to about 2 hours, about 0.5 hours to about 1.5 hours, about 1 hour to about 6 hours, about 1 hour to about 5.5 hours, about 1 hour to about 5 hours, about 1 hour to about 4.5 hours, about 1 hour to about 4 hours, about 1 hour to about 3.5 hours, about 1 hour to about 3 hours, about 1 hour to about 2.5 hours, about 1 hour to about 2 hours, about 1.5 hours to about 6 hours, about 1.5 hours to about 5.5 hours, about 1.5 hours to about 5 hours, about 1.5 hours to about 4.5 hours, about 1.5 hours to about 4 hours, about 1.5 hours to about 3.5 hours, about 1.5 hours to about 3 hours, about 1.5 hours to about 2.5 hours, about 2 hours to about 6 hours, about 2 hours to about 5.5 hours, about 2 hours to about 5 hours, about 2 hours to about 4.5 hours, about 2 hours to about 4 hours, about 2 hours to about 3.5 hours, about 2 hours to about 3 hours, about 2.5 hours to about 6 hours, about 2.5 hours to about 5.5 hours, about 2.5 hours to about 5 hours, about 2.5 hours to about 4.5 hours, about 2.5 hours to about 4 hours, about 2.5 hours to about 3.5 hours, about 3 hours to about 6 hours, about 3 hours to about 5.5 hours, about 3 hours to about 5 hours, about 3 hours to about 4.5 hours, about 3 hours to about 4 hours, about 3.5 hours to about 6 hours, about 3.5 hours to about 5.5 hours, about 3.5 hours to about 5 hours, about 3.5 hours to about 4.5 hours, about 4 hours to about 6 hours, about 4 hours to about 5.5 hours, about 4 hours to about 5 hours, about 4.5 hours to about 6 hours, about 4.5 hours to about 5.5 hours, about 5 hours to about 6 hours.

In any aspect or embodiment described herein, reacting a resin acid composition and a C₃₋₉ carboxylic-acid-bearing dienophile comprises, consists essentially of, or consists of: (i) heating the resin acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.); (ii) heating the resin acid composition and the C₃₋₉ carboxylic-acid-bearing dienophile reaction mixture for up to about 6 hours; or (iii) a combination thereof.

In any aspect or embodiment described herein, reacting a resin acid composition and a C₃₋₉ carboxylic-acid-bearing dienophile comprises, consists essentially of, or consists of: (i) heating the resin acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours); (ii) cooling the resin acid reaction product (e.g., cooling the emulsifier reaction product to a temperature of about 60° C. to about 100° C., about 60° C. to about 80° C., or about 70° C.); or (iii) a combination thereof.

In any aspect or embodiment described herein, the reaction for the emulsifier reaction product is stopped or sufficiently complete when the acid number is about 180 to about 230 mg KOH/g, the free maleic anhydride is <0.15%, or a combination of both. In any aspect or embodiment described herein, the emulsifier reaction product is cooled when the acid number is about 180 to about 230 mg KOH/g, the free maleic anhydride is <0.15%, or a combination of both.

In any aspect or embodiment described herein, reacting a resin composition and a C₃₋₉ carboxylic-acid-bearing dienophile comprises, consists essentially of, or consists of, heating the resin acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.). For example, in any aspect or embodiment described herein, the resin acid composition and the C₃₋₉ carboxylic-acid-bearing dienophile reaction mixture is heated to about 200° C. to about 240° C., about 200° C. to about 235° C., about 200° C. to about 230° C., about 200° C. to about 225° C., about 200° C. to about 220° C., about 200° C. to about 215° C., about 200° C. to about 210° C., about 205° C. to about 240° C., about 205° C. to about 235° C., about 205° C. to about 230° C., about 205° C. to about 225° C., about 205° C. to about 220° C., about 205° C. to about 215° C., about 210° C. to about 240° C., about 210° C. to about 235° C., about 210° C. to about 230° C., about 210° C. to about 225° C., about 210° C. to about 220° C., about 215° C. to about 240° C., about 215° C. to about 235° C., about 215° C. to about 230° C., about 215° C. to about 225° C., about 220° C. to about 240° C., about 220° C. to about 235° C., about 220° C. to about 230° C., about 225° C. to about 240° C., about 225° C. to about 235° C., or about 230° C. to about 240° C.

In any aspect or embodiment described herein, reacting the resin acid composition and a C₃₋₉ carboxylic-acid-bearing dienophile comprises, consists essentially of, or consists of, heating the resin acid composition and the C₃₋₉ carboxylic-acid-bearing dienophile reaction mixture for up to about 6 hours. For example, in any aspect or embodiment described herein, the resin acid composition and the C₃₋₉ carboxylic-acid-bearing dienophile reaction mixture is heated for up to about 6 hours, up to about 5.5 hours, up to about 5 hours, up to about 4.5 hours, up to about 4 hours, up to about 3.5 hours, up to about 3 hours, up to about 2.5 hours, up to about 2 hours, up to about 1.5 hours up to about an hour, up to about 0.5 hours, about 0.5 hours to about 6 hours, about 0.5 hours to about 5.5 hours, about 0.5 hours to about 5 hours, about 0.5 hours to about 4.5 hours, about 0.5 hours to about 4 hours, about 0.5 hours to about 3.5 hours, about 0.5 hours to about 3 hours, about 0.5 hours to about 2.5 hours, about 0.5 hours to about 2 hours, about 0.5 hours to about 1.5 hours, about 1 hour to about 6 hours, about 1 hour to about 5.5 hours, about 1 hour to about 5 hours, about 1 hour to about 4.5 hours, about 1 hour to about 4 hours, about 1 hour to about 3.5 hours, about 1 hour to about 3 hours, about 1 hour to about 2.5 hours, about 1 hour to about 2 hours, about 1.5 hours to about 6 hours, about 1.5 hours to about 5.5 hours, about 1.5 hours to about 5 hours, about 1.5 hours to about 4.5 hours, about 1.5 hours to about 4 hours, about 1.5 hours to about 3.5 hours, about 1.5 hours to about 3 hours, about 1.5 hours to about 2.5 hours, about 2 hours to about 6 hours, about 2 hours to about 5.5 hours, about 2 hours to about 5 hours, about 2 hours to about 4.5 hours, about 2 hours to about 4 hours, about 2 hours to about 3.5 hours, about 2 hours to about 3 hours, about 2.5 hours to about 6 hours, about 2.5 hours to about 5.5 hours, about 2.5 hours to about 5 hours, about 2.5 hours to about 4.5 hours, about 2.5 hours to about 4 hours, about 2.5 hours to about 3.5 hours, about 3 hours to about 6 hours, about 3 hours to about 5.5 hours, about 3 hours to about 5 hours, about 3 hours to about 4.5 hours, about 3 hours to about 4 hours, about 3.5 hours to about 6 hours, about 3.5 hours to about 5.5 hours, about 3.5 hours to about 5 hours, about 3.5 hours to about 4.5 hours, about 4 hours to about 6 hours, about 4 hours to about 5.5 hours, about 4 hours to about 5 hours, about 4.5 hours to about 6 hours, about 4.5 hours to about 5.5 hours, about 5 hours to about 6 hours.

In any aspect or embodiment described herein, (i) the reaction mixture of the fatty acid reaction product further comprises, consists essentially of, or consists of, a catalyst that isomerize fatty acids into conjugated system (e.g., a catalyst, such as iodine, present in an amount of up to about 0.5 wt % of the reaction mixture); (ii) the reaction mixture of the resin acid reaction product further comprises, consists essentially of, or consists of, a catalyst that isomerize fatty acids into conjugated system (e.g., isomerize linoleic acid to conjugated linoleic) (e.g., a catalyst, such as iodine, present in an amount of up to about 0.5 wt % of the reaction mixture); or (iii) a combination thereof. For example, in any aspect or embodiment described herein, the catalyst that isomerize fatty acids into conjugated system is present in an amount independently of up to about 0.5 wt %, up to about 0.4 wt %, up to about 0.3 wt %, up to about 0.2 wt %, up to about 0.1 wt %, about 0.05 wt % to about 0.5 wt %, about 0.05 wt % to about 0.4 wt %, about 0.05 wt % to about 0.3 wt %, about 0.05 wt % to about 0.2 wt %, about 0.05 wt % to about 0.1 wt %, about 0.1 wt % to about 0.5 wt %, about 0.1 wt % to about 0.4 wt %, about 0.1 wt % to about 0.3 wt %, about 0.1 wt % to about 0.2 wt %, about 0.2 wt % to about 0.5 wt %, about 0.2 wt % to about 0.4 wt %, about 0.2 wt % to about 0.3 wt %, about 0.3 wt % to about 0.5 wt %, about 0.4 wt % to about 0.4 wt %, or about 0.5 wt % to about 0.5 wt % of the reaction mixture of the fatty acid reaction product, the resin acid reaction product, or a combination thereof. In any aspect or embodiment described herein, the a catalyst that isomerize fatty acids into conjugated system includes or is a heterogenous catalyst system (e.g., Au, Ru, Ni, Pd, Pt, Rh, Ir, Os, bimetallic Pt—Rh, or a combination thereof, supported by activated carbon, Al₂O₃, SiO₂Al₂O₃, MCM-22, H-MCM-41, H-Y, H-B, or a combination hereof), an alkali catalyst (e.g., NaOH, KOH, LiOH, alkoxides, or a mixture thereof), a Brønsted acid (e.g., HCl, H₂SO₄, HNO₃, H₃PO₄, CH₃CO₂H, or a mixture thereof), a Lewis acid (e.g., BF₃, I₂, H⁺, HCl, Cu²⁺, CO₂, SiBr₄, AlF₃, H₂O, or a mixture thereof), acidic clays (e.g., montmorillonite, bentonite, kaolimite, or a mixture thereof), molecular sieves, sulfur compound or active sulfur compound (e.g., sulfur dioxide, sulfur, disulfides, or a mixture thereof), metallocene catalyst (e.g., ferrocene, molybdocene, or a combination thereof), or a combination thereof.

In any aspect or embodiment described herein, the reaction mixture of the fatty acid reaction product does not include a catalyst (e.g., a catalyst that isomerize fatty acids into conjugated system). In any aspect or embodiment described herein, the reaction mixture of the resin acid reaction product does not include a catalyst (e.g., a catalyst that isomerize fatty acids into conjugated system).

### C₃₋₉ Carboxylic-Acid-Bearing Dienophile

In any aspect or embodiment described herein, the C₃₋₉ carboxylic-acid-bearing dienophile includes or is maleic acid, maleic anhydride, fumaric acid, itaconic acid, or a combination thereof. For example, in any aspect or embodiment described herein, the C₃₋₉ carboxylic-acid-bearing dienophile includes or is maleic acid, maleic anhydride, fumaric acid, itaconic acid, or a combination thereof.

### Fatty Acid Composition and Resin Acid Composition

In any aspect or embodiment described herein, the fatty acid composition includes, is, or is derived from, oleic acid, stearic acid, palmitic acid, linoleic, linolenic, a natural fatty acid mixture, crude tall oil (CTO), distilled tall oil (DTO), tall oil fatty acids (TOFA, such as Type I TOFA, Type II TOFA, Type III TOFA, or a combination thereof), vegetable oil fatty acid composition, a derivative or modified version thereof, or a mixture thereof.

In any aspect or embodiment described herein, the additional fatty acid composition includes, is, or is derived from, oleic acid, stearic acid, palmitic acid, linoleic, linolenic, a natural fatty acid mixture, crude tall oil (CTO), distilled tall oil (DTO), tall oil fatty acids (TOFA, such as Type I TOFA, Type II TOFA, Type III TOFA, or a combination thereof), vegetable oil fatty acid composition, a derivative or modified version thereof, or a mixture thereof.

In any aspect or embodiment described herein, the vegetable oil fatty acid composition includes, is, or is derived from, soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof. In any aspect or embodiment described herein, the vegetable oil fatty acid composition includes or is soybean oil or derivative thereof, olive oil or derivative thereof, corn oil or derivative thereof, coconut oil or derivative thereof, tallow oil or derivative thereof, canola oil or derivative thereof, sesame oil or derivative thereof, rice bran oil or derivative thereof, almond oil or derivative thereof, rapeseed oil or derivative thereof, safflower oil or derivative thereof, grapeseed oil or derivative thereof, thistle oil or derivative thereof, cottonseed oil or derivative thereof, hemp oil or derivative thereof, sunflower oil or derivative thereof, wheat germ oil or derivative thereof, pumpkin seed oil or derivative thereof, peanut oil or derivative thereof, or a mixture thereof.

In any aspect or embodiment described herein, the fatty acid composition is a modified fatty acid. In any aspect or embodiment described herein, the fatty acid composition a fatty acid composition that has undergone hydrolyzation, oxidation, polymerization, hydrogenation, isomerization, conjugation, a reaction with a dienophile, or a combination thereof. For example, in any aspect or embodiment described herein, the fatty acid composition is a hydrolyzed fatty acid composition, an oxidized fatty acid composition, a polymerized fatty acid composition, a hydrogenated fatty acid composition, an isomerized fatty acid composition, a conjugated fatty acid composition, a fatty acid composition that has been reacted with a dienophile, or a combination thereof.

In any aspect or embodiment described herein, the fatty acid composition is a vegetable oil or derivative thereof or a modified vegetable oil. In any aspect or embodiment described herein, the fatty acid composition is canola oil or hydrolyzed canola oil. In any aspect or embodiment described herein, the fatty acid composition is a distillate of canola oil or hydrolyzed canola oil. In any aspect or embodiment described herein, the fatty acid composition comprises, consists essentially of, or consists of, about 65% to about 75% (e.g., about 68% to about 72% or about 70%) oleic acid, about 15 to about 20% linoleic acid, up to about 8% (e.g., up to about 5%) palmitic acid, and up to about 8% (e.g., up to about 5%) stearic acid.

In any aspect or embodiment described herein, (i) the resin acid composition includes or is one or more carboxylic acids, wherein each carboxylic acid has (a) three fused rings, (b) one acid group, (c) the formula C₁₉H₂₉COOH, C₂₀H₂₈O₂, or C₂₀H₃₀O₂, or (d) a combination thereof; (ii) the resin acid composition includes or is one or more C₁₉₋₂₀ tricyclic terpenoids (e.g., one or more tricyclic terpenoid, each independently having the formula C₁₉H₂₉COOH, C₂₀H₂₈O₂, or C₂₀H₃₀O₂); or (iii) a combination thereof.

In any aspect or embodiment described herein, the resin acid composition comprises, consists essentially of, or consists of, one or more carboxylic acids, wherein each carboxylic acid has (i) three fused rings, (ii) one acid group, (iii) the formula C₁₉H₂₉COOH, C₂₀H₂₈O₂, or C₂₀H₃₀O₂, or (iv) a combination thereof. For example, in any aspect or embodiment described herein, the resin acid composition comprises, consists essentially of, or consists of, one or more C₁₉₋₂₀ tricyclic terpenoids (e.g., one or more tricyclic terpenoid, each independently having the formula C₁₉H₂₉COOH, C₂₀H₂₈O₂, or C₂₀H₃₀O₂).

In any aspect or embodiment described herein, the resin acid composition includes or is palustric acid, abietic acid, neoabietic acid, pimaric acid, isopimaric acid, dehydroabietic acid, rosin, tall oil rosin (TOR), gum rosin, wood rosin, or a combination thereof.

In any aspect or embodiment described herein, (i) the fatty acid composition includes or is vegetable oil fatty acid composition or vegetable oil; (ii) the resin acid composition includes or is rosin or tall oil rosin (TOR); (iii) the C₃₋₉ carboxylic-acid-bearing dienophile includes or is fumaric acid, itaconic acid, or a combination thereof; or (iv) a combination thereof.

Tall Oil Fatty Acids (TOFA) is produced as a byproduct of the Kraft pulping process of coniferous trees. In particular, the kraft pulping process is utilized to convert wood into wood pulp, wherein crude tall oil (CTO) is produced as a byproduct. Crude tall oil can be upgraded through distillation to produce rosin-rich distillates and distilled tall oil. Distillation streams produce tall oil pitch (TOP), tall oil rosin (TOR), head streams (light ends), tall oil fatty acids (TOFA), and distilled tall oil (DTO). Pine tree-derived TOR contains several C20 acid isomers including abietic, dehydroabietic, and pimaric acids. TOFA comprises primarily C18 linear saturated and unsaturated chains (for example, linoleic acid, oleic acid, and linolenic acid). The principle composition and yields of tall oil fractions and some empirical volatility data is provided in Table 1, and exemplary data and composition of some crude tall oil is provided in Table 2, some tall oil fatty acids are provided in Table 3, and some rosin in Table 4.

TABLE 1
Composition and Yields of Tall Oil Fractions
and Empirical Volatility Data*

| | | | Composition (%) | | |
|---|---|---|---|---|---|
| | Yield | Acid | Rosin/Resin | Fatty | |
| | (%) | Number | Acids | Acids | Neutrals |
| Head, light ends | 5-12 | 70-120 | <0.5 | 30-50 | 40-60 |
| Tall Oil Fatty | 35-45 | 192-197 | <2 | 95-98 | 1-2 |
| Acids | | | | | |
| Distilled Tall Oil | 5-15 | 180-190 | 20-30 | 65-70 | 4-7 |
| Tall Oil Rosin | 20-35 | 165-182 | 85-96 | 1-5 | 1-7 |
| Tall Oil Pitch | 20-40 | 20-50 | 5-13 | 5-10 | 40-60 |

*Adapted from Table 6 of Norlin, H., et al., Ullmann's Encyclopedia of Industrial Chemistry.
Volume 35, pages 583-596 (Tall Oil). 7^{th} Edition. 2012.

TABLE 2
Exemplary Data and Composition of Crude Tall Oil*

| | Scandinavia | United States | Canada | |
|---|---|---|---|---|
| | (typical mix) | (pine) | (mixed) | France |
| Acid Number | 145 | 165 | 140 | 165 |
| Saponification | 160 | 172 | 165 | 172 |
| Number | | | | |
| Fatty Acids (%) | 45 | 45 | 42 | 40 |
| Palmitic (16:0) | 1.5 | 3 | 2 | 2 |
| Stearic (18:0) | 0.5 | 1 | 1 | 1 |
| Oleic (18:1) | 10 | 20 | 10 | 15 |
| Linoleic (18:2) | 17 | 13 | 15 | 11 |
| Pinolenic (18:3) | 5 | 1 | 3 | 1 |
| Arachidic (20:0) | 1 | 0.5 | 1 | 0.5 |
| Other | 10 | 6.5 | 10 | 9.5 |
| Rosin/Resin Acids (%) | 30 | 42 | 30 | 50 |
| Pimaric | 2 | 3 | 2 | 5 |
| Palustric | 4 | 7 | 5 | 7 |
| Isopimaric | 2 | 4 | 4 | 4 |
| Abietic | 12 | 15 | 10 | 18 |
| Dehydroabietic | 5 | 4 | 4 | 5 |
| Neoabietic | 4 | 6 | 3 | 6 |
| Others | 1 | 3 | 2 | 5 |
| Neutrals (%) | 25 | 13 | 28 | 10 |

| | |
|---|---|
| Moisture | <2% |
| Ash | <0.2% |
| Mineral Acid (H₂SO₄) | <0.02% |
| Sulfur | <0.03% |

*Adapted from Table 3 of Norlin, H., et al., Ullmann's Encyclopedia of Industrial Chemistry.
Volume 35, pages 583-596 (Tall Oil). 7^{th} Edition. 2012.

TABLE 3
Exemplary Data and Composition of Tall Oil Fatty Acids*

| | Scandinavia | United States |
|---|---|---|
| Acid Number | 195 | 197 |
| Rosin/Resin Acid (%) | 2 | 1 |
| Unsaponifiables (%) | 2 | 1.5 |
| Iodine Value | 150 | 130 |
| Color, Garner | 4 | 3 |
| Fatty Acids (%) | | |
| Saturated | 2 | 2 |
| Oleic (18:1) | 30 | 48 |
| Linoleic (18:2) | 44 | 37 |
| Linolenic (18:3) | 10 | 3 |
| Conjugated (18:2) | 6 | 6 |
| Other | 4 | 2.5 |

*Adapted from Table 7 of Norlin, H., et al., Ullmann's Encyclopedia of Industrial Chemistry.
Volume 35, pages 583-596 (Tall Oil). 7^{th} Edition. 2012.

TABLE 4
Exemplary Data and Composition of Crude Tall Oil*

| | | | Tall Oil Rosin | | |
|---|---|---|---|---|---|
| | Rum | Wood | United | Scandinavia | |
| | Rosin | Rosin | States | I | II |
| Acid Number | 167 | 157 | 174 | 173 | 180 |
| Rosin/Resin acids | 90 | 85 | 92 | 90 | 95 |
| (%) | | | | | |
| Fatty Acids (%) | | | 2 | 4 | 2 |
| Softening point (° C.) | 78 | 73 | 75 | 66 | 75 |
| Color, USDA** | | | WW | X | XA |
| Composition of | | | | | |
| Rosin/Resin Acid | | | | | |
| Fraction (%) | | | | | |
| Pimaric | 7 | 7 | 2 | 3 | 3 |
| Palustric | 20 | 8 | 7 | 8 | 7 |
| Isopimaric | 15 | 15 | 8 | 6 | 6 |
| Abietic | 30 | 50 | 40 | 40 | 40 |
| Dehydroabietic | 5 | 8 | 20 | 22 | 23 |
| Neoabietic | 15 | 5 | 3 | 4 | 4 |

*Adapted from Table 8 of Norlin, H., et al., Ullmann's Encyclopedia of Industrial Chemistry.
Volume 35, pages 583-596 (Tall Oil). 7^{th} Edition. 2012.
**For a definition of USDA color shaves, see Resins, Natural, Section 5.4.

Tall oil fatty acids (TOFA) is further broken down into Type I (minimum of 98% fatty acids and a maximum of 1% rosin/resin acids), Type II (minimum of 96% fatty acids and a maximum of 2% rosin/resin acids), and Type III (minimum of 90% fatty acids and a maximum of 10% rosin/resin acids), as shown in Table 5, depending upon acid value, rosin/resin acids concentration, unsaponifiables concentration, fatty acids concentration, Gardner color, and iodine value.

TABLE 5
Tall Oil Fatty Acids Requirements*

| | | Type I | | Type II | | Type III | |
|---|---|---|---|---|---|---|---|
| | Method | Min | Max | Min | Max | Min | Max |
| Acid Value | ASTM D1980 | 197 | — | 192 | — | 190 | — |
| Rosin/Resin Acids (%) | ASTM D1240 | — | 1.0 | — | 2.0 | — | 10.0 |
| Unsaponifiables (%) | ASTM D1965 | — | 1.0 | — | 2.0 | — | 10.0 |
| Fatty Acids (%) | ASTM D1983 | 98 | — | 96 | — | 90 | — |
| Color, Gardner | ASTM D1544 | — | 4 | — | 5 | — | 10.0 |
| Iodine Value | ASTM D1959 | 125 | 135 | — | — | — | — |

*Adapted from Table 1 of American Society for Testing and Materials (ASTM): D1984-69 (Standard Specification for Tall Oil Fatty Acids).

The standard methods recited in Table 4 can be utilized to determine the acid number, rosin/resin acid concentration (%), unsaponifiables concentration (%), fatty acids concentration (%), Gardner color, and iodine value of fatty acid compositions.

The fatty acid composition of sixteen exemplary vegetable oils, determined by gas chromatography, is shown in Table 6.

TABLE 6
Exemplary Data and Composition of Sixteen Exemplary Vegetable Oils*^{†}

| FAs [%] | SAF | GRP | SIL | HMP | SFL | WHG | PMS | SES | RB | ALM | RPS | PNT | OL | COC | TA | CO |
|---|---|---|---|---|---|---|---|---|---|---|---|---|---|---|---|---|
| C6:0 | ND | ND | ND | ND | ND | ND | ND | ND | ND | ND | ND | ND | ND | 0.52 | ND | ND |
| C8:0 | ND | 0.01 | ND | ND | ND | ND | ND | ND | ND | ND | ND | ND | ND | 7.6 | ND | ND |
| C10:0 | ND | ND | ND | ND | ND | ND | ND | ND | ND | ND | 0.01 | ND | ND | 5.5 | ND | ND |
| C12:0 | ND | 0.01 | 0.01 | ND | 0.02 | 0.07 | ND | ND | ND | 0.09 | ND | ND | ND | 47.7 | 0 | 0 |
| C14:0 | 0.10 | 0.05 | 0.09 | 0.07 | 0.09 | ND | 0.17 | ND | 0.39 | 0.07 | ND | 0.04 | ND | 19.9 | 4 | 1 |
| C15:0 | ND | 0.01 | 0.02 | ND | ND | 0.04 | ND | ND | ND | ND | 0.02 | ND | ND | ND | ND | ND |
| C16:0 | 6.7 | 6.6 | 7.9 | 6.4 | 6.2 | 17.4 | 13.1 | 9.7 | 20.0 | 6.8 | 4.6 | 7.5 | 16.5 | ND | 28 | 3 |
| C17:0 | 0.04 | 0.06 | 0.06 | 0.05 | 0.02 | 0.03 | 0.13 | ND | ND | 0.05 | 0.04 | 0.07 | ND | ND | ND | ND |
| C18:0 | 2.4 | 3.5 | 4.5 | 2.6 | 2.8 | 0.7 | 5.7 | 6.5 | 2.1 | 2.3 | 1.7 | 2.1 | 2.3 | 2.7 | 23 | 2 |
| C20:0 | ND | 0.16 | 2.6 | ND | 0.21 | ND | 0.47 | 0.63 | ND | 0.09 | ND | 1.01 | 0.43 | ND | ND | ND |
| C22:0 | ND | ND | ND | ND | ND | ND | ND | 0.14 | ND | ND | ND | ND | 0.15 | ND | ND | ND |
| C16:1 (n-7) | 0.08 | 0.08 | 0.05 | 0.11 | 0.12 | 0.21 | 0.12 | 0.11 | 0.19 | 0.53 | 0.21 | 0.07 | 1.8 | ND | ND | ND |
| C17:1 (n-7) | ND | ND | 0.03 | ND | ND | ND | ND | ND | ND | ND | ND | ND | ND | ND | ND | ND |
| C18:1 (n-9) | ND | ND | ND | ND | ND | ND | ND | ND | ND | ND | ND | ND | ND | ND | 35 | 58 |
| C18:1cis (n-9) | 11.5 | 14.3 | 20.4 | 11.5 | 28.0 | 12.7 | 24.9 | 41.5 | 42.7 | 67.2 | 63.3 | 71.1 | 66.4 | 6.2 | ND | ND |
| C18:1trans (n-9) | ND | ND | ND | ND | ND | ND | ND | ND | ND | ND | 0.14 | ND | ND | ND | ND | ND |
| C20:1(n-9) | ND | 0.40 | 0.15 | 16.5 | 0.18 | 7.91 | 1.08 | 0.32 | 1.11 | 0.16 | 9.1 | ND | 0.30 | ND | ND | ND |
| C18:2cis (n-6) | 79.0 | 74.7 | 63.3 | 59.4 | 62.2 | 59.7 | 54.2 | 40.9 | 33.1 | 22.8 | 19.6 | 18.2 | 16.4 | 1.6 | 2 | 9 |
| C18:3 | ND | ND | ND | ND | ND | ND | ND | ND | ND | ND | ND | ND | ND | ND | 1 | 23 |
| C18:3 (n-3) | 0.15 | 0.15 | 0.88 | 0.36 | 0.16 | 1.2 | 0.12 | 0.21 | 0.45 | ND | 1.2 | ND | 1.6 | ND | ND | ND |
| C18:3 (n-6) | ND | ND | ND | 3.0 | ND | ND | ND | ND | ND | ND | ND | ND | ND | ND | ND | ND |
| SFAs | 9.3 | 10.4 | 15.1 | 9.2 | 9.4 | 18.2 | 19.6 | 16.9 | 22.5 | 9.3 | 6.3 | 10.7 | 19.4 | 92.1 | ND | ND |
| MUFAs | 11.6 | 14.8 | 20.7 | 28.1 | 28.3 | 20.9 | 26.1 | 42.0 | 44.0 | 67.9 | 72.8 | 71.1 | 68.2 | 6.2 | ND | ND |
| PUFAs | 79.1 | 74.9 | 64.2 | 62.8 | 62.4 | 61.0 | 54.3 | 41.2 | 33.6 | 22.8 | 20.9 | 18.2 | 18.0 | 1.6 | ND | ND |
| n-3 PUFAs | 0.2 | 0.2 | 0.9 | 0.4 | 0.2 | 1.2 | 0.1 | 0.2 | 0.5 | 0.0 | 1.2 | 0.0 | 1.6 | 0.0 | ND | ND |
| n-6 PUFAs | 79.0 | 74.7 | 63.3 | 62.4 | 62.2 | 59.7 | 54.2 | 40.9 | 33.1 | 22.8 | 19.6 | 18.2 | 16.4 | 1.6 | ND | ND |

*Data are expressed as percentages of total fatty acid methyl esters (FAMEs); ND means that FAs was not determined. Abbreviations of the samples mean: SFA—saturated fatty acids, MUFA—monounsaturated fatty acids, PUFA—polyunsaturated fatty acids, SAF—safflower oil, GRP—grapeseed oil, SIL— silybum marianum (thistle oil), HMP—hemp oil, SFL—sunflower oil, WHG—wheat germ oil, PMS—pumpkin seed oil, SES—sesame oil, RB—rice bran oil, ALM—almond oil, RPS—rapeseed oil, PNT—peanut oil, OL—olive oil, COC—coconut oil, TA—tallow oil, and CA—canola oil.
^{†}Adapted from Table 1 of Orsavova, J., et al., Int. J. Mol. Sci. 2015. 16: 12871-12890.

### Oil-Based Drilling Fluid and Methods of Using Oil-Based Drilling Fluid

Another aspect of the present disclosure provides an oil-based drilling fluid or mud comprising an invert emulsion of a hygroscopic liquid (e.g., a brine, such as CaCl₂) brine), one or more (e.g., 1, 2, 3, 4, 5, 6, 7, 8, or more) emulsifiers, and at least one of: an oil, mineral oil, synthetic oil, or a combination thereof, wherein the one or more emulsifiers includes one or more of the emulsifier compositions of the present disclosure, one or more of the emulsifier compositions produced according to the method or process of the present disclosure, or a combination thereof. In any aspect or embodiment described herein, the synthetic oil includes or is internal olefin, poly alpha olefin, linear paraffin, or a combination thereof. A further aspect of the present disclosure provides an oil-based drilling fluid or mud consisting essentially of an invert emulsion of a hygroscopic liquid (e.g., a brine, such as CaCl₂) brine), one or more (e.g., 1, 2, 3, 4, 5, 6, 7, 8, or more) emulsifiers, and at least one of: an oil, mineral oil, synthetic oil, or a combination thereof, wherein the one or more emulsifiers includes one or more of the emulsifier compositions of the present disclosure, one or more of the emulsifier compositions produced according to the method or process of the present disclosure, or a combination thereof. In any aspect or embodiment described herein, the synthetic oil includes or is internal olefin, poly alpha olefin, linear paraffin, or a combination thereof. An additional aspect of the present disclosure provides an oil-based drilling fluid or mud consisting of, an invert emulsion of a hygroscopic liquid (e.g., a brine, such as CaCl₂) brine), one or more (e.g., 1, 2, 3, 4, 5, 6, 7, 8, or more) emulsifiers, and at least one of: an oil, mineral oil, synthetic oil, or a combination thereof, wherein the one or more emulsifiers includes one or more of the emulsifier compositions of the present disclosure, one or more of the emulsifier compositions produced according to the method or process of the present disclosure, or a combination thereof. In any aspect or embodiment described herein, the synthetic oil includes or is internal olefin, poly alpha olefin, linear paraffin, or a combination thereof.

In any aspect or embodiment described herein, the oil is diesel.

In any aspect or embodiment described herein, the hygroscopic liquid is CaCl₂) brine, NaCl brine, NaBr brine, CaBr₂ brine, a formate brine, potassium formate, an alcohol based hygroscopic liquid, lower polyhydric alcohols, glycerol, or polyglycerol. In any aspect or embodiment described herein, the hygroscopic liquid is CaCl₂) brine.

In any aspect or embodiment described herein, the drilling fluid or mud further comprises one or more weighting agents (e.g., barite).

In any aspect or embodiment described herein, the drilling fluid or mud further comprises one or more (e.g., 1, 2, 3, 4, 5, 6, 7, 8, or more) rheological modifier (e.g., clay, organophilic clay, bentonite clay, amine-treated clay, amine-treated bentonite clay, a polyamide, a dimer diacid, or combinations thereof).

In any aspect or embodiment described herein, the drilling fluid or mud further comprises one or more alkalinity agent (e.g., lime, CaO, or Ca(OH)₂).

In any aspect or embodiment described herein, the drilling fluid or mud further comprises one or more wetting agent (e.g., fatty imidazolines, soya lecithin, or combinations thereof).

In any aspect or embodiment described herein, the oil-based drilling fluid or mud comprises: an invert emulsion of a hygroscopic liquid (e.g., a brine, such as CaCl₂) brine), the emulsifier composition of the present disclosure, and an oil that includes diesel), mineral oil, internal olefin, or a combination thereof.

An additional aspect of the present disclosure provides a method of drilling a wellbore, the method comprising circulating the oil-based drilling fluid of the present disclosure through the wellbore when drilling.

A further aspect of the present disclosure provides a method of drilling a wellbore, the method comprising circulating the oil-based drilling fluid of the present disclosure through the wellbore when drilling the well to depth.

### EXAMPLES

### Example 1: Making the Emulsifier with One Reaction Product

Exemplary emulsifier were prepared and examined utilizing the reactants and formulations shown in Table 7.

TABLE 7
Exemplary Emulsifier Formulations

| | | | | | | Reaction |
|---|---|---|---|---|---|---|
| | | | | | | Temperature (° C.) |
| | | | | | | [incubation period] |
| | | Fatty | | | | (acid number of |
| Emulsifier | | Acids | Rosin S | Iodine | Dienophile | emulsifier) |
| 1 | Percent (%) of | 63 | 31 | | | 225° C. |
| | Composition | | | | | [15 minutes] |
| | Percent (%) | 94.00 | | | 6.00 | (207.5 mg KOH/g) |
| | Charge | | | | | |
| | Amount (g) | 236.87 | 116.56 | | 24.00 | |
| | | | | | [fumaric | |
| | | | | | acid] | |
| 2 | Percent (%) of | 59 | 29 | | | 225° C. |
| | Composition | | | | | [3 hours] |
| | Percent (%) | 88.00 | | | 12.00 | (227.3 mg KOH/g) |
| | Charge | | | | | |
| | Amount (g) | 207.68 | 102.08 | | 48.00 | |
| | | | | | [fumaric | |
| | | | | | acid] | |
| 3 | Percent (%) of | 63 | 31 | | | 210° C. |
| | Composition | | | | | [3 hours] |
| | Percent (%) | 93.80% | | 0.20% | 6.00 | (206.8 mg KOH/g) |
| | Charge | | | | | |
| | Amount (g) | 220.05 | 108.28 | 0.70 | 21.00 | |
| | | | | | [fumaric | |
| | | | | | acid] | |
| 4 | Percent (%) of | 59 | 29 | | | 210° C. |
| | Composition | | | | | [3 hours] |
| | Percent (%) | 87.80 | | 0.20 | 12.00 | (not determined) |
| | Charge | | | | | |
| | Amount (g) | 206.09 | 101.3 | 0.70 | 42.00 | |
| | | | | | [itaconic | |
| | | | | | acid] | |
| 5 | Percent (%) of | 59 | 29 | | 12.00 | 225° C. |
| | Composition | | | | | [3 hours] |
| | Percent (%) | 100 | | | | (not determined) |
| | Charge | | | | | |
| | Amount (g) | 206.50 | 101.5 | | 42.00 | |
| | | | | | [itaconic | |
| | | | | | acid] | |
| 6 | Percent (%) of | 65 | 35 | | | 210° C. |
| | Composition | | | | | [3 hours] |
| | Percent (%) | 58.37 | 31.43 | 0.2 | 10.00 | (244.9 mg KOH/g) |
| | Charge | | | | | |
| | Amount (g) | 175.11 | 94.29 | 0.6 | 30.00 | |
| 7 | Percent (%) of | 80 | 20 | | | 210° C. |
| | Composition | | | | | [3 hours] |
| | Percent (%) | 70.32 | 17.54 | 0.3 | 12.00 | (258.6 mg KOH/g) |
| | Charge | | | | | |
| | Amount (g) | 210.48 | 52.62 | 0.90 | 36.00 | |
| 8 | Percent (%) of | 80 | 20 | | | 210° C. |
| | Composition | | | | | [3 hours] |
| | Percent (%) | 70.16 | 17.54 | 0.3 | 12.00 | (243.2 mg KOH/g) |
| | Charge | | | | | |
| | Amount (g) | 210.48 | 52.62 | 0.90 | 36.00 | |
| 9 | Percent (%) of | 80 | 20 | | | 210° C. |
| | Composition | | | | | [3 hours] |
| | Percent (%) | 73.36 | 18.34 | 0.3 | 8.00 | (215.7 mg KOH/g) |
| | Charge | | | | | |
| | Amount (g) | 220.08 | 55.02 | 0.90 | 24.00 | |
| 10 | Percent (%) of | 80 | 20 | | | 210° C. |
| | Composition | | | | | [3 hours] |
| | Percent (%) | 73.52 | 18.38 | 0.1 | 8.00 | (218.4 mg KOH/g) |
| | Charge | | | | | |
| | Amount (g) | 220.56 | 55.14 | 0.30 | 24.00 | |

Briefly, Rosin S (Ingevity, Inc., North Charleston, South Carolina) was crushed and added to Alta Veg™ FFA (fatty acids, vegetable oil; Ingevity, Inc; North Charleston, South Carolina) articulated for each exemplary emulsifier in Table 7. Alta Veg™ FFA contains about 70% palmitic acid, <5% stearic acid, and the remainder is unsaturated C₁₈ fatty acids. Next, the dienophile, as articulated for each exemplary emulsifier in Table 7, was crushed and added to the reaction mixture. The reaction mixtures were purged four times with nitrogen. The reaction mixtures where then stirred at 60 rotations per minute while being heated to 210° C. to 225° C., as indicated in Table 7, and incubated for the period of time indicated in Table 7 while stirring at 150 rotations per minute. The resultant exemplary emulsifiers were cooled to 70° C.

The acid number of exemplary emulsifiers was examined and are shown in Table 7. Briefly, two grams of the emulsifier was added to a beaker. The emulsifier was dissolved in isopropanol or a mixture of methanol and toluene using agitation and/or heat, as required for complete dissolution. Acid number (AN) was determined via titration with 0.5 N KOH in methanol on an 888 Titrando Autotitrator (Metrohm, Riverview, FL).

Further exemplary emulsifier were prepared and examined utilizing the reactants and formulations shown in Table 8.

TABLE 8
Exemplary Emulsifier Formulations

| | 16 | 17 |
|---|---|---|
| AltaVeg ™ D600 | 53.46% | 57.32% |
| | (374.22) | (1462.60) |
| Altapyne ® Rosin TD | 35.64% | 38.21% |
| | (249.7) | (975.1) |
| Coconut Fatty Acid | 0.90% | 0.97% |
| | (6.4) | (24.8) |
| Maleic anhydride | 10.00% | 3.50% |
| | (71.2) | (89.32) |
| Acid Number of Emulsifier | | 195.3 |

Briefly, Altapyne® Rosin TD (100% rosin; Ingevity, Inc; North Charleston, South Carolina) was crushed and added to Alta Veg™ D 600 (Ingevity, Inc; North Charleston, South Carolina) articulated for each exemplary emulsifier in Table 8. AltaVeg™ D 600 is a distillate obtained by distillation of Alta Veg™ ND 600 (Ingevity, Inc; North Charleston, South Carolina) that has a similar fatty acid distribution as Alta Veg™ ND 600, but for the residual mono-glycerides and di-glycerides being removed, and reduced concentrations of palmitic and stearic acid. AltaVeg™ ND 600 (hydrolyzed canola oil, which has a fatty acid composition of about 70% oleic acid, about 15-20% linoleic acid, about 5% palmitic acid, and about 5% stearic acid; Ingevity, Inc; North Charleston, South Carolina).

For exemplary Emulsifier 16, the mixture of Altapyne® Rosin TD and Alta Veg™ D 600 was heated to 120° C. and blended for 30 minutes. The maleic anhydride was crushed and added to the mixture at a temperature of 120° C. to 130° C. The reaction mixture was then increased to a temperature of 225° C. over a 2.5 hours period and then held at 225° C. for up to 2 hours, such that the acid number is about 180 to about 230 mg KOH/g and the free maleic anhydride is <0.15%. The emulsifier was cooled to 85° C. and the acid number determined.

For exemplary Emulsifier 17, the maleic anhydride was crushed and added to the mixture. The reaction mixture was heated to 225° C. while being stirred. Once 225 C was reached, the reaction mixture was cooled to 70 C and the acid number determined (195.3).

### Example 2: Making the Emulsifier by Blending Reaction Products

An exemplary formulation for the resin acid reaction product is shown in Table 9.

TABLE 9
Exemplary Resin Acid Reaction Product

| | Percent (%) Charge | Amount Charged (g) |
|---|---|---|
| Rosin R-24 | 87.5 | 875.18 |
| Maleic Anhydride | 12.5 | 125.28 |
| Typical Charge | 100.0 | |
| Typical Yield | 95.0 | 951.45 |

Briefly, Rosin R-24 (Ingevity, Inc; North Charleston, South Carolina) was added to a vessel with a nitrogen blanket and a condenser having water flowing therethrough. The rosin was heated to 180° C. and stirred at 90 rotations per minute. The nitrogen sweep was stopped and the maleic anhydride was added, avoiding clumping. The reaction mixture was heated to 205° C. and held there for 1 hour to produce the exemplary resin acid reaction product.

Maleated rosin, maleated tall oil fatty acids (Tenax® 2010; Ingevity, Inc; North Charleston, South Carolina), and Alta Veg™ ND 600 (hydrolyzed canola oil, which has a fatty acid composition of about 70% oleic acid, about 15-20% linoleic acid, about 5% palmitic acid, and about 5% stearic acid; Ingevity, Inc; North Charleston, South Carolina) were blended as shown in the formulations of Table 10. Briefly, 100 g of each blend was produced using weight to weight ratios. AltaVeg™ ND 600 was warmed to 80° C., and the maleated tall oil fatty acids was added and the mixture stirred for 10 minutes. Next, the maleated rosin acids were added and the mixture stirred for 20 minutes. If undissolved material was present, the mixture was stirred for an additional 15 minutes.

TABLE 10
Exemplary Emulsifier Blends of the Present Disclosure

| | Maleated Rosin | Tenax ® 2010 | AltaVeg ™ ND 600 |
|---|---|---|---|
| Emulsifier | (wt %) | (wt %) | (wt %) |
| 11 | 55 | 10 | 35 |
| 12 | 40 | 10 | 50 |
| 13 | 30 | 20 | 50 |
| 14 | 20 | 30 | 50 |
| 15 | 20 | 60 | 20 |
| 18 | 38.75 | 18.75 | 42.5 |
| 19 | 70 | 10 | 20 |
| 20 | 53.75 | 18.75 | 27.5 |
| 21 | 28.75 | 43.75 | 27.5 |
| 22 | 28.75 | 28.75 | 42.5 |
| 23 | 37.5 | 27.5 | 35 |
| 24 | 53.75 | 36.25 | 10 |
| 25 | 28.75 | 61.25 | 10 |
| 26 | 52.5 | 5 | 42.5 |
| 27 | 20 | 10 | 70 |
| 28 | 45 | 35 | 20 |
| 29 | 20 | 45 | 35 |
| 30 | 10 | 46.25 | 42.5 |

### Example 3: Examination of Catalysts Effect of Resultant Composition

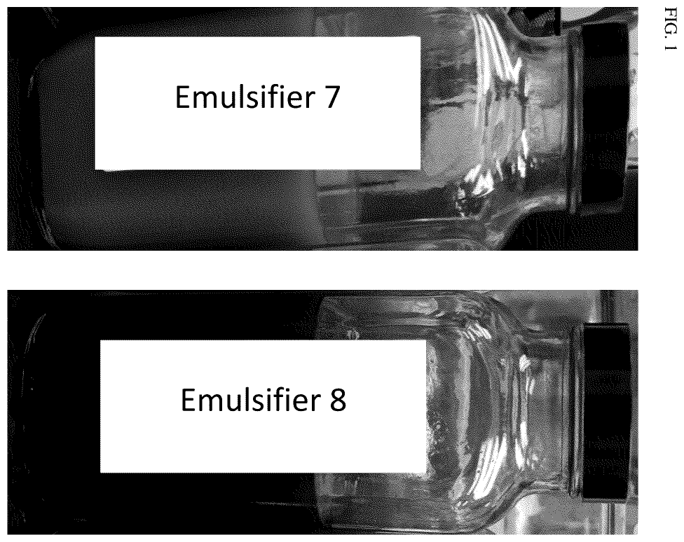

Overall, it was observed that the exemplary emulsifiers produced with lower amounts of catalyst were cloudy and had a layer of sediment that settled out over time, while the exemplary emulsifiers produced with higher amounts of catalyst were not cloudy and did not have a layer of sediment settle out. FIG. 1 shows an exemplary pair of emulsifier compositions of the present disclosure illustrating the above-observation, wherein the pair has the same fatty acid composition and resin acid composition, at the same amounts, but prepared with different amounts of iodine as a catalyst. In particular, FIG. 1 includes pictures comparing exemplary Emulsifier 7 (0.1% iodine) and exemplary Emulsifier 8 (0.3% iodine). Both contained 12% fumaric acid reacted with a mixture of 20% rosin acids and 80% Alta Veg™ FFA. Exemplary Emulsifier 7 is cloudy and exemplary Emulsifier 8 is homogenous.

### Example 4: Making Oil-Based Drilling Fluid

Performance of the emulsifier composition of the present disclosure was tested in an oil-based/invert drilling fluid formulation. The formulation details are shown in Table 11 (Emulsifiers 1-5), Table 12 (Emulsifiers 6-15 and 18-30), and Table 13 (Emulsifiers 16 and 17). The exemplary oil-based drilling fluid was prepared by sequentially adding the ingredients listed in Tables 11-13 and mixing for the indicated period of time with a Hamilton Beach (Glen Allen, Virginia) mixer on medium. After preparing the oil-based/invert drilling fluid, the drilling fluid was then hot rolled at 150° F. for 16 hours. The oil-based drilling fluid was then remixed on a multi-mixer on high for 5 minutes for Emulsifiers 1-5 and 10 minutes for Emulsifiers 6-15 and 18-30. The 350 mL oil-based drilling fluids had a weight of 503.3 g for emulsifiers 1-15 and 18-30 and 495.0 g for Emulsifiers 16 and 17, with an actual mud weight of 12.0 g for Emulsifiers 1-30, an actual mud density of 1.44 g/mL for Emulsifiers 1-15 and 18-30 and 1.43 g/mL for Emulsifiers 16 and 17, and oil/water ratio (OWR) of 0.75 for Emulsifiers 1-30.

TABLE 11
Exemplary oil-based drilling fluid formulation
of the present disclosure

| Component (density) | Drilling Fluid | Mixing |
|---|---|---|
| Low Sulfur Diesel Oil (0.86 g/mL) | 215.4 mL | |
| | [185.3 g] | |
| Primary Emulsifier (0.99 g/mL) | 6.1 mL | 5 |
| | [6.0 g] | |
| Lime (Ca(OH)₂; 2.24 g/mL) | 1.3 mL | 10 |
| | [3.0 g] | |
| 25% CaCl₂ Brine (1.23 g/mL) | 71.8 mL | 10 |
| | [88.3 g] | |
| Organophilic Lignite (1.8 g/mL) | 2.2 mL | 10 |
| | [4.0] | |
| Organoclay (1.6 g/mL) | 2.5 mL | 10 |
| | [4.0] | |
| Barite (4.2 g/mL) | 50.6 mL | 20 |
| | [212.7 g] | |

TABLE 12
Exemplary oil-based drilling fluid formulation
of the present disclosure

| Component (density) | Drilling Fluid | Mixing |
|---|---|---|
| Low Sulfur Diesel Oil (0.86 g/mL) | 215.4 mL | |
| | [185.3 g] | |
| Primary Emulsifier (0.99 g/mL) | 6.1 mL | 5 |
| | [6.0 g] | |
| Lime (Ca(OH)₂; 2.24 g/mL) | 1.3 mL | 5 |
| | [3.0 g] | |
| 25% CaCl₂ Brine (1.23 g/mL) | 71.8 mL | 5 |
| | [88.3 g] | |
| Organophilic Lignite (1.8 g/mL) | 2.2 mL | 5 |
| | [4.0] | |
| Organoclay (1.6 g/mL) | 2.5 mL | 5 |
| | [4.0] | |
| Barite (4.2 g/mL) | 50.6 mL | 20 |
| | [212.7 g] | |

TABLE 13
Exemplary oil-based drilling fluid formulation
of the present disclosure

| Component (density) | Drilling Fluid | Mixing |
|---|---|---|
| Low Sulfur Diesel Oil (0.86 g/mL) | 211.6 mL | |
| | [182.0 g] | |
| Primary Emulsifier (0.93 g/mL) | 6.5 mL | 5 |
| | [6.0 g] | |
| Lime (Ca(OH)₂; 2.24 g/mL) | 1.3 mL | 10 |
| | [3.0 g] | |
| 25% CaCl₂ Brine (1.19 g/mL) | 70.6 mL | 10 |
| | [84.0 g] | |
| Organophilic Lignite (1.05 g/mL) | 3.8 mL | 10 |
| | [4.0] | |
| Organoclay (2.55 g/mL) | 1.6 mL | 10 |
| | [4.0] | |
| Barite (4.2 g/mL) | 50.5 mL | 20 |
| | [212.0 g] | |

### Example 5: Examining the Oil-Based Drilling Fluid

The rheological properties and emulsion stability (ES) were examined according to the methods described in API Recommended Practice 13B-2, Fourth Edition, Recommended Practice for Field Testing of Oil-based Drilling Fluids. Briefly, the oil-based drilling fluid was aged for 16 hours at 300° F. under 200 pounds per square inch (psi) nitrogen for Emulsifiers 1-5 and 150 pounds per square inch (psi) nitrogen for Emulsifiers 6-17 using a stainless-steel rolling aging cell. After aging, the fluid was remixed using a steal mixing cup and a Hamilton Beach mixer at medium mixing speed. The rheological properties of the oil-based drilling fluid were then examined using an OFITE® 900 series rotational rheometer at 120° F. for Emulsifiers 1-5 and at 150° F. for Emulsifiers 6-31. Emulsion stability (ES) was measured using an OFITE® ES meter with the fluid maintained at 120° F. for Emulsifiers 1-5 and at 150° F. for Emulsifiers 6-30. High Temperature High Pressure Fluid Loss (HTHP) testing was conducted at 300° F. with a 500 psi differential between the top and bottom pressures. Separated fluid was collected from the bottom port of the HTHP apparatus to measure fluid loss of the mud during the test.

The performance characteristics are shown in Tables 14-19. EnvaMul® 600 (a modified tall oil-based emulsifier; Ingevity, Inc; North Charleston, South Carolina), EnvaMul® 690 (modified tall oil derivative emulsifier; Ingevity, Inc; North Charleston, South Carolina), and EnvaMul® 2157 (an emulsifier that is a mixture of proprietary tall oil derivative (97.5%) and proprietary tall oil derivative zinc salt (2.5%); Ingevity, Inc; North Charleston, South Carolina) was also examined in the exemplary oil-based/invert drilling fluids. Rheological properties and other performance factors were within typical ranges for oil-based muds.

TABLE 14
Performance properties for exemplary oil-based drilling fluid with exemplary
emulsifiers of the present disclosure and EnvaMul ® 600

| | Exemplary Emulsifier No. | | | | | |
|---|---|---|---|---|---|---|
| Performance Properties (AHR) | 1 | 2 | 3 | 4 | 5 | EnvaMul ® 600 |
| Shear Stress for 600 RPM (DR) | 42 | | 36.9 | 35.2 | 33.2 | 33.8 |
| Shear Stress for 300 RPM (DR) | 21.3 | | 18.6 | 17.7 | 16.8 | 17 |
| Shear Stress for 200 RPM (DR) | 13.3 | | 11.3 | 11.1 | 10.5 | 9.9 |
| Shear Stress for 100 RPM (DR) | 7.6 | | 6 | 5.4 | 5.3 | 4.8 |
| Shear Stress for 6 RPM (DR) | 0.7 | | 0.8 | 0 | 0.3 | 0.4 |
| Shear Stress for 3 RPM (DR) | 0.6 | | 0.5 | 0 | 0.2 | 0.4 |
| Plastic Viscosity (PV) (cP) | 20.7 | | 18.3 | 17.5 | 16.4 | 16.8 |
| Yield Point (YP) (lb/100 ft²) | 0.6 | | 0.3 | 0.2 | 0.4 | 0.2 |
| Gel Strength 10 Seconds (DR) | 1 | | 1 | 0 | 0 | 0 |
| Gel Strength 10 Minutes (DR) | 3 | | 4 | 4 | 4 | 2 |
| Emulsion Stability (ES) (V) | 602 | | 432 | 280 | 484 | 823 |
| High Temperature High | 10.4 | 8.8 | 9.6 | 4 | 5 | 6.8 |
| Pressure Fluid Loss @ 500 psi | | | | | | |
| and 300° F. (mL) | | | | | | |
| Water (mL) | 0 | 0 | 0.6 | 0 | 0 | 0 |

TABLE 15
Performance properties for exemplary oil-based drilling fluid
with exemplary emulsifiers of the present disclosure

| | Exemplary Emulsifier No. | | | | |
|---|---|---|---|---|---|
| Performance Properties (AHR) | 6 | 7 | 8 | 9 | 10 |
| Shear Stress for 600 RPM (DR) | 36.4 | 37.6 | 46.7 | 30.0 | 38.0 |
| Shear Stress for 300 RPM (DR) | 18.4 | 17.9 | 21.5 | 15.3 | 19.3 |
| Shear Stress for 200 RPM (DR) | 11.2 | 11.0 | 13.2 | 9.9 | 11.6 |
| Shear Stress for 100 RPM (DR) | 5.7 | 5.6 | 6.7 | 4.5 | 5.8 |
| Shear Stress for 6 RPM (DR) | 0.6 | 0.4 | 0.4 | 0.0 | 0.1 |
| Shear Stress for 3 RPM (DR) | 0.4 | 0.3 | 0.3 | 0.0 | 0.0 |
| Plastic Viscosity (PV) (cP) | 18.0 | 19.7 | 25.2 | 14.7 | 18.7 |
| Yield Point (YP) (lb/100 ft²) | 0.4 | −1.8 | −3.7 | 0.6 | 0.6 |
| Gel Strength 10 Seconds (DR) | 0 | 0 | 0 | 0 | 0 |
| Gel Strength 10 Minutes (DR) | 4 | 2 | 5 | 2 | 3 |
| Emulsion Stability (ES) (V) | 557 | 723 | 497 | — | 328 |
| High Temperature High Pressure | 6.0 | 10.0 | 6.0 | 8.4 | 10.8 |
| Fluid Loss @ 500 psi and 300° | | | | | |
| F. (mL) | | | | | |
| Water (mL) | 0.0 | 0.0 | 0.0 | 0.0 | 0.0 |
| Filter Cake/32 inches | 8 | — | — | 12 | 8 |

TABLE 16
Performance properties for exemplary oil-based drilling fluid
with exemplary emulsifiers of the present disclosure

| | Exemplary Emulsifier No. | | | | |
|---|---|---|---|---|---|
| Performance Properties (AHR) | 11 | 12 | 13 | 14 | 15 |
| Shear Stress for 600 RPM (DR) | 23.9 | 22.3 | 29.2 | 30.3 | 36.1 |
| Shear Stress for 300 RPM (DR) | 12.6 | 11.9 | 16.1 | 16.0 | 18.2 |
| Shear Stress for 200 RPM (DR) | 8.4 | 7.0 | 10.3 | 9.4 | 11.9 |
| Shear Stress for 100 RPM (DR) | 3.7 | 3.5 | 5.3 | 5.2 | 6.2 |
| Shear Stress for 6 RPM (DR) | 0.3 | 0.0 | 1 | 1.0 | 1.3 |
| Shear Stress for 3 RPM (DR) | 0.3 | 0.0 | 1 | 0.9 | 1.3 |
| Plastic Viscosity (PV) (cP) | 11.3 | 10.4 | 13.1 | 14.3 | 17.9 |
| Yield Point (YP) (lb/100 ft²) | 1.3 | 1.5 | 3 | 1.7 | 0.3 |
| Gel Strength 10 Seconds (DR) | 1 | 0 | 1 | 1 | 1 |
| Gel Strength 10 Minutes (DR) | 3 | 2 | 4 | 3 | 9 |
| Emulsion Stability (ES) (V) | 379 | — | 311 | — | — |
| High Temperature High Pressure | 7 | 4.2 | 4 | 1.6 | 3.6 |
| Fluid Loss @ 500 psi and 300° | | | | | |
| F. (mL) | | | | | |
| Water (mL) | 0.0 | 0.0 | 0.0 | 0.0 | 0.0 |

TABLE 17
Performance properties for exemplary oil-based drilling fluid
with exemplary emulsifiers of the present disclosure

| Performance | Exemplary Emulsifier No. | | | | | | |
|---|---|---|---|---|---|---|---|
| Properties (AHR) | 18 | 19 | 20 | 21 | 22 | 23 | 24 |
| Shear Stress for 600 RPM (DR) | 30.8 | 29.6 | 29.1 | 27.7 | 28.9 | 28.8 | 28.3 |
| Shear Stress for 300 RPM (DR) | 15.8 | 15.1 | 14.4 | 14.6 | 14.3 | 15.3 | 14.5 |
| Shear Stress for 200 RPM (DR) | 9.5 | 9.1 | 9.1 | 8.8 | 9.0 | 9.2 | 9.7 |
| Shear Stress for 100 RPM (DR) | 4.9 | 4.6 | 4.2 | 4.6 | 3.8 | 4.7 | 5.1 |
| Shear Stress for 6 RPM (DR) | 0.7 | 0.5 | 0.3 | 0.5 | 0.5 | 0.6 | 1.0 |
| Shear Stress for 3 RPM (DR) | 0.6 | 0.4 | 0.2 | 0.4 | 0.4 | 0.5 | 0.9 |
| Plastic Viscosity (PV) (cP) | 15.0 | 14.5 | 14.7 | 13.1 | 14.6 | 13.5 | 13.8 |
| Yield Point (YP) (lb/100 ft²) | 0.8 | 0.6 | −0.3 | 1.5 | −0.3 | 1.8 | 0.7 |
| Gel Strength 10 Seconds (DR) | 1 | 0 | 0 | 0 | 0 | 0 | 2 |
| Gel Strength 10 Minutes (DR) | 3 | 3 | 2 | 3 | 2 | 3 | 3 |
| Emulsion Stability (ES) (V) | — | — | — | — | — | — | 365 |
| High Temperature High | 4.2 | 18.6 | 4.4 | 4.2 | 3.8 | 4.2 | 17.2 |
| Pressure Fluid Loss @ 500 psi | | | | | | | |
| and 300° F. (mL) | | | | | | | |
| Water (mL) | 0.0 | 1.6 | 0.0 | 0.0 | 0.0 | 0.0 | 6.0 |

TABLE 18
Performance properties for exemplary oil-based drilling fluid
with exemplary emulsifiers of the present disclosure

| Performance | Exemplary Emulsifier No. | | | | | |
|---|---|---|---|---|---|---|
| Properties (AHR) | 25 | 26 | 27 | 28 | 29 | 30 |
| Shear Stress for 600 RPM (DR) | 27.1 | 28.8 | 24.6 | 24.0 | 28.0 | 28.7 |
| Shear Stress for 300 RPM (DR) | 13.9 | 14.1 | 14.0 | 12.5 | 15.7 | 15.5 |
| Shear Stress for 200 RPM (DR) | 8.1 | 8.6 | 9.0 | 7.4 | 9.6 | 9.2 |
| Shear Stress for 100 RPM (DR) | 3.6 | 4.3 | 5.0 | 3.1 | 5.1 | 4.9 |
| Shear Stress for 6 RPM (DR) | 0.2 | 0.7 | 1.2 | 0.2 | 0.6 | 0.7 |
| Shear Stress for 3 RPM (DR) | 0.1 | 0.6 | 1.2 | 0.1 | 0.5 | 0.6 |
| Plastic Viscosity (PV) (cP) | 13.2 | 14.7 | 10.6 | 11.5 | 12.3 | 13.2 |
| Yield Point (YP) (lb/100 ft²) | 0.7 | −0.6 | 3.4 | 1.0 | 3.4 | 2.3 |
| Gel Strength 10 Seconds (DR) | 0 | 0 | 1 | 0 | 0 | 0 |
| Gel Strength 10 Minutes (DR) | 2 | 2 | 3 | 3 | 4 | 4 |
| Emulsion Stability (ES) (V) | 414 | 298 | 170 | 552 | 387 | 337 |
| High Temperature High | 14.0 | 11.2 | 40.0 | 8.8 | 4.8 | 5.2 |
| Pressure Fluid Loss @ 500 psi | | | | | | |
| and 300° F. (mL) | | | | | | |
| Water (mL) | 1.0 | 0.0 | 12.0 | | | |

TABLE 19
Performance properties for exemplary oil-based drilling fluid
with exemplary emulsifiers of the present disclosure

| | Exemplary Emulsifier No. | | EnvaMul ® | EnvaMul ® |
|---|---|---|---|---|
| Performance Properties (AHR) | 16 | 17 | 600 | 2157 |
| Shear Stress for 600 RPM (DR) | 33.3 | 26.8 | 26.7 | 27.7 |
| Shear Stress for 300 RPM (DR) | 17.6 | 14.8 | 14.7 | 13.9 |
| Shear Stress for 200 RPM (DR) | 11.2 | 8.9 | 9.2 | 8.3 |
| Shear Stress for 100 RPM (DR) | 6.0 | 4.9 | 5.0 | 4.5 |
| Shear Stress for 6 RPM (DR) | 1.5 | 0.6 | 1.6 | 0.8 |
| Shear Stress for 3 RPM (DR) | 1.3 | 0.5 | 1.6 | 0.8 |
| Plastic Viscosity (PV) (cP) | 15.7 | 12.0 | 12.0 | 13.8 |
| Yield Point (YP) (lb/100 ft²) | 1.9 | 2.8 | 2.7 | 0.1 |
| Gel Strength 10 Seconds (DR) | 1 | 1 | 1 | 1 |
| Gel Strength 10 Minutes (DR) | 8 | 2 | 3 | 3 |
| Emulsion Stability (ES) (V) | 1139 | 469 | 289 | 566 |
| High Temperature High Pressure | 6.4 | 11.4 | 73.0 | 6.4 |
| Fluid Loss @ 500 psi and 300° | | | | |
| F. (mL) | | | | |
| Water (mL) | 0.0 | 0.0 | 10.0 | 0.0 |

It was surprising and unexpectedly discovered that the exemplary emulsifiers of the present disclosure produced stable emulsions, as demonstrated through fluid loss control in high-temperature, high pressure fluid loss tests, as compared to current commercially available emulsifiers (e.g., oxidized fatty acids).

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references or publication are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range. “Combinations” is inclusive of blends, mixtures, alloys, reaction products, and the like. The terms “first”, “second”, and the like, do not denote any order, quantity, or importance, but rather are used to denote one element from another.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. An emulsifier composition comprising, consisting essentially of, or consisting of:
(a) an emulsifier reaction product comprising, consisting essentially of, or consisting of, reacting:
a fatty acid composition (e.g., a fatty acid composition present in an amount of about 40.0 wt % to about 75.0 wt % of the reaction mixture);
a resin acid composition (e.g., a resin acid composition present in an amount of about 20.0 wt % to about 50.0 wt % of the reaction mixture); and
a C₃₋₉ carboxylic-acid-bearing dienophile (e.g., a C₃₋₉ carboxylic-acid-bearing dienophile present in an amount of about 6.0 wt % to about 12.0 wt % of the reaction mixture); or
(b) an emulsifier blend comprising, consisting essentially of, or consisting of:
a fatty acid reaction product made by a process comprising, consisting essentially of, or consisting of, reacting a fatty acid composition and a C₃₋₉ carboxylic-acid-bearing dienophile (e.g., the fatty acid composition is present in an amount of about 70.0 wt % to about 90.0 wt % (e.g., about 75.0 wt % to about 80.0 wt %) of the reaction mixture, the C₃₋₉ carboxylic-acid-bearing dienophile present in an amount of about 10.0 wt % to about 30.0 wt % (e.g., about 20.0 wt % to about 25.0 wt %) of the reaction mixture, or a combination thereof);
a resin acid reaction product made by a process comprising, consisting essentially of, or consisting of, reacting a resin acid composition and a C₃₋₉ carboxylic-acid-bearing dienophile (e.g., the resin acid composition present in an amount of about 86.0 wt % to about 92.0 wt % (e.g., about 87.0 wt % to about 90.0 wt %) of the reaction mixture, the C₃₋₉ carboxylic-acid-bearing dienophile present in an amount of about 8.0 wt % to about 14.0 wt % (e.g., about 10.0 wt % to about 13.0 wt %) of the reaction mixture, or a combination thereof); and
an additional fatty acid composition.

2. The emulsifier of claim 1, wherein the reaction mixture of the emulsifier reaction product comprises, consists essentially of, or consists of:
the fatty acid composition in an amount about 40.0 wt % to about 75.0 wt % (e.g., about 53.0 wt % to about 60.0 wt %, about 53.0 wt %, about 54.0 wt %, about 55.0 wt %, about 56.0 wt %, about 57.0 wt %, about 58.0 wt %, about 59.0 wt %, or about 60.0 wt %);
the resin acid composition an amount of about 20.0 wt % to about 50.0 wt % (e.g., about 30.0 wt % to about 35.0 wt %, about 30.0 wt %, about 31.0 wt %, about 32.0 wt %, about 33.0 wt %, about 34.0 wt %, or about 35.0 wt %);
the C₃₋₉ carboxylic-acid-bearing dienophile an amount of about 6.0 wt % to about 12.0 wt % (e.g., about 10.0 wt % to about 12.0 wt %, about 10.0 wt %, about 11.0 wt %, or about 12.0 wt %); or
a combination thereof.

3. The emulsifier of claim 1, wherein reacting the fatty acid composition, the resin acid composition, and the C₃₋₉ carboxylic-acid-bearing dienophile, comprises, consists essentially of, or consists of:
heating the fatty acid composition, the resin acid composition, and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.);
heating the fatty acid composition, the resin acid composition, and the C₃₋₉ carboxylic-acid-bearing dienophile reaction mixture for up to about 6 hours; or
a combination thereof.

4. The emulsifier of claim 1, wherein reacting the fatty acid composition, the resin acid composition, and the C₃₋₉ carboxylic-acid-bearing dienophile, comprises, consists essentially of, or consists of:
heating the fatty acid composition, the resin acid composition, and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours);
cooling the emulsifier reaction product (e.g., cooling the emulsifier reaction product to a temperature of about 60° C. to about 100° C., about 60° C. to about 80° C., or about 70° C.); or
a combination thereof.

5. The emulsifier of claim 1, wherein the reaction mixture of the emulsifier reaction product further comprises, consists essentially of, or consists of, a catalyst that isomerize fatty acids into conjugated system (e.g., a catalyst, such as, iodine present in an amount of up to about 1.0 wt % (e.g., up to about 0.8 wt %, up to about 0.6 wt %, up to about 0.4 wt %, up to about 0.2 wt %, about 0.05 wt % to about 1.0 wt %, or about 0.2 wt %) of the reaction mixture).

6. The emulsifier of claim 1, wherein:
the reaction mixture of the fatty acid reaction product comprises, consists essentially of, or consists of, the fatty acid composition in an amount of about 70.0 wt % to about 90.0 wt % (e.g., about 75.0 wt % to about 80.0 wt %), the C₃₋₉ carboxylic-acid-bearing dienophile in an amount of about 10.0 wt % to about 30.0 wt % % (e.g., about 20.0 wt % to about 25.0 wt %), or a combination thereof;
the reaction mixture of the resin acid reaction product comprises, consists essentially of, or consists of, the resin acid composition in an amount of about 86.0 wt % to about 92.0 wt % (e.g., about 87.0 wt % to about 90.0 wt %), the C₃₋₉ carboxylic-acid-bearing dienophile in an amount of about 8.0 wt % to about 14.0 wt % (e.g., about 10.0 wt % to about 13.0 wt %), or a combination thereof;
the fatty acid reaction product is present in an amount of about 10.0 wt % to about 60.0 wt % (e.g., about 10.0 wt % to about 30.0 wt %) of the emulsifier blend, the resin acid reaction product is present in an amount of about 20.0 wt % to about 55.0 wt % (e.g., about 30.0 wt % to about 50.0 wt %) of the emulsifier blend, the additional fatty acid composition is present in an amount of about 20.0 wt % to about 50.0 wt % (e.g., about 40.0 wt % to about 60.0 wt %) of the emulsifier blend, or a combination thereof; or
a combination thereof.

7. The emulsifier of 1, wherein the emulsifier blend comprises, consists essentially of, or consists of:
the combination of the fatty acid reaction product and the resin acid reaction product are present in an amount of about 45.0 wt % to about 80.0 wt %;
a ratio of resin acid reaction product to fatty acid reaction product is about 1:5 to about 5:1; or
a combination thereof.

8. The emulsifier of claim 1, wherein reacting a fatty acid composition and a C₃₋₉ carboxylic-acid-bearing dienophile comprises, consists essentially of, or consists of:
heating the fatty acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.);
heating the fatty acid composition and the C₃₋₉ carboxylic-acid-bearing dienophile reaction mixture for up to about 6 hours; or
a combination thereof.

9. The emulsifier of claim 1, wherein reacting a resin acid composition and a C₃₋₉ carboxylic-acid-bearing dienophile comprises, consists essentially of, or consists of:
heating the resin acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.);
heating the resin acid composition and the C₃₋₉ carboxylic-acid-bearing dienophile reaction mixture for up to about 6 hours; or
a combination thereof.

10. The emulsifier of claim 1, wherein reacting a fatty acid composition and a C₃₋₉ carboxylic-acid-bearing dienophile comprises, consists essentially of, or consists of:
heating the fatty acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours);
cooling the fatty acid reaction product (e.g., cooling the emulsifier reaction product to a temperature of about 60° C. to about 100° C., about 60° C. to about 80° C., or about 70° C.); or
a combination thereof.

11. The emulsifier of claim 1, wherein reacting a resin acid composition and a C₃₋₉ carboxylic-acid-bearing dienophile comprises, consists essentially of, or consists of:
heating the resin acid composition and the C₃₋₉ carboxylic-acid-bearing dienophile reaction mixture to about 200° C. to about 240° C. (e.g., about 210° C. to about 230° C., about 210° C. to about 225° C., or about 215° C. to about 225° C.) for about 2 hours to about 6 hours (e.g., about 2 hours to about 5.5 hours, about 2 hours to about 5 hours, about 2 hours to about 4 hours, about 2.5 hours to about 3.5 hours, or about 3 hours);
cooling the resin acid reaction product (e.g., cooling the emulsifier reaction product to a temperature of about 60° C. to about 100° C., about 60° C. to about 80° C., or about 70° C.); or
a combination thereof.

12. The emulsifier of claim 1, further comprising, consisting essentially of, or consisting of, blending the fatty acid reaction product, the resin acid reaction product, and the additional fatty acid composition.

13. The emulsifier of claim 1, wherein:
the reaction mixture of the fatty acid reaction product further comprises, consists essentially of, or consists of, a catalyst that isomerize fatty acids into conjugated system (e.g., a catalyst, such as iodine, present in an amount of up to about 0.5 wt %) of the reaction mixture);
the reaction mixture of the resin acid reaction product further comprises, consists essentially of, or consists of, a catalyst that isomerize fatty acids into conjugated system (e.g., a catalyst, such as iodine, present in an amount of up to about 0.5 wt % of the reaction mixture); or
a combination thereof.

14. The emulsifier of claim 1, wherein:
the fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof;
the resin acid composition includes or is one or more carboxylic acids, wherein each carboxylic acid has (i) three fused rings, (ii) one acid group, (iii) the formula C₁₉H₂₉COOH, C₂₀H₂₈O₂, or C₂₀H₃₀O₂, or (iv) a combination thereof;
the resin acid composition includes or is one or more C₁₉₋₂₀ tricyclic terpenoids (e.g., one or more tricyclic terpenoid, each independently having the formula C₁₉H₂₉COOH, C₂₀H₂₈O₂, or C₂₀H₃₀O₂);
the additional fatty acid composition includes or is oleic acid, stearic acid, palmitic acid, linoleic, linolenic, a natural fatty acid mixture, crude tall oil (CTO), distilled tall oil, tall oil fatty acids (TOFA, such as Type I TOFA, Type II TOFA, Type III TOFA, or a combination thereof), vegetable oil fatty acid composition, a derivative or modified version thereof, or a mixture thereof; or
a combination thereof.

15. The emulsifier of claim 14, wherein:
the vegetable oil fatty acid composition includes, is, or is derived from, vegetable oil, soybean oil, olive oil, corn oil, coconut oil, tallow oil, canola oil, sesame oil, rice bran oil, almond oil, rapeseed oil, safflower oil, grapeseed oil, thistle oil, cottonseed oil, hemp oil, sunflower oil, wheat germ oil, pumpkin seed oil, peanut oil, or a mixture thereof;
the resin acid composition includes or is palustric acid, abietic acid, neoabietic acid, pimaric acid, isopimaric acid, dehydroabietic acid, rosin, tall oil rosin (TOR), gum rosin, wood rosin, or a combination thereof;
the C₃₋₉ carboxylic-acid-bearing dienophile includes or is maleic acid, maleic anhydride, fumaric acid, itaconic acid, or a combination thereof; or
a combination thereof.

16. The emulsifier of claim 1, wherein:
the fatty acid composition includes or is vegetable oil fatty acid composition or vegetable oil;
the resin acid composition includes or is rosin or tall oil rosin (TOR);
the C₃₋₉ carboxylic-acid-bearing dienophile includes or is fumaric acid, itaconic acid, or a combination thereof; or
a combination thereof.

17. A method of making an emulsifier composition of claim 1, the method comprising, consisting essentially of, or consisting of:
(a) reacting:
a fatty acid composition (e.g., a fatty acid composition present in an amount of about 40.0 wt % to about 75.0 wt % of the reaction mixture);
a resin acid composition (e.g., a resin acid composition present in an amount of about 20.0 wt % to about 50.0 wt % of the reaction mixture); and
a C₃₋₉ carboxylic-acid-bearing dienophile (e.g., a C₃₋₉ carboxylic-acid-bearing dienophile present in an amount of about 6.0 wt % to about 12.0 wt % of the reaction mixture), thereby forming an emulsifier reaction product; or
(b) blending:
a fatty acid reaction product made by a process comprising, consisting essentially of, or consisting of, reacting a fatty acid composition and a C₃₋₉ carboxylic-acid-bearing dienophile (e.g., the fatty acid composition is present in an amount of about 70.0 wt % to about 90.0 wt % of the mixture, the C₃₋₉ carboxylic-acid-bearing dienophile present in an amount of about 10.0 wt % to about 30.0 wt % of the reaction mixture, or a combination thereof);
a resin acid reaction product made by a process comprising, consisting essentially of, or consisting of, reacting a resin acid composition and a C₃₋₉ carboxylic-acid-bearing dienophile (e.g., the resin composition present in an amount of about 86.0 wt % to about 92.0 wt % of the reaction mixture, the C₃₋₉ carboxylic-acid-bearing dienophile present in an amount of about 8.0 wt % to about 14.0 wt % of the reaction mixture, or a combination thereof); and
an additional fatty acid composition,
thereby forming an emulsifier blend.

18. An oil-based drilling fluid comprising, consisting essentially of, or consisting of, an invert emulsion of a hygroscopic liquid (e.g., a brine, such as CaCl₂) brine), one or more emulsifier, and at least one of: an oil, mineral oil, synthetic oil (e.g., one or more of internal olefin, poly alpha olefin, and linear paraffin), or a combination thereof,
wherein the one or more emulsifiers includes the emulsifier composition of claim 1.

19. The oil-based drilling fluid of claim 18, wherein:
the oil is diesel;
the hygroscopic liquid is CaCl₂) brine, NaCl brine, NaBr brine, CaBr₂ brine, formate brine, potassium formate, an alcohol based hygroscopic liquid, lower polyhydric alcohols, glycerol, or polyglycerol (e.g., CaCl₂) brine); or
a combination thereof.

20. The oil-based drilling fluid of claim 18, further comprising:
one or more weighting agents (e.g., barite);
one or more rheological modifier (e.g., at least one of: clay, organophilic clay, organoclay, bentonite clay, amine-treated clay, amine-treated bentonite clay, polyamide, dimer diacid, or combinations thereof);
one or more alkalinity agent (e.g., lime, CaO, or Ca(OH)₂);
one or more wetting agent (e.g., fatty imidazolines, soya lecithin, or combinations thereof); or
a combination thereof.

21. The oil-based drilling fluid of claim 18, wherein the oil-based drilling fluid comprises an invert emulsion of a hygroscopic liquid (e.g., a brine, such as CaCl₂) brine), the emulsifier composition, and an oil that includes diesel, mineral oil, internal olefin, or a combination thereof.

22. A method of drilling a wellbore, the method comprising circulating the oil-based drilling fluid of claim 18 through the wellbore when drilling (e.g., when drilling the well to depth).
